(19) United States
(12) Patent Application Publication
(10) Pub. No.: US 2025/0267631 A1
(43) Pub. Date: Aug. 21, 2025

(54) INTERFERENCE MITIGATION METHODS FOR BACKSCATTERED AMBIENT INTERNET OF THINGS TRANSMISSIONS

(71) Applicant: APPLE INC., Cupertino, CA (US)

(72) Inventors: Huaning Niu, San Jose, CA (US); Dawei Zhang, Saratoga, CA (US); Wei Zeng, Saratoga, CA (US); Sigen Ye, San Diego, CA (US); Hong He, San Jose, CA (US); Ankit Bhamri, Munich (DE); Haitong Sun, Cupertino, CA (US)

(21) Appl. No.: 19/035,532

(22) Filed: Jan. 23, 2025

Related U.S. Application Data
(60) Provisional application No. 63/553,804, filed on Feb. 15, 2024.

(51) Int. Cl. H04W 72/044; H04W 72/232; H04W 72/542

(52) U.S. Cl. CPC H04W 72/044; H04W 72/232; H04W 72/542

(57) ABSTRACT

Systems and methods for interference mitigation for backscattered ambient internet of things(IoT) transmissions are discussed herein. A base station sends, to a first user equipment (UE) and to a second UE, a downlink control information (DCI) instructing the first UE and the second UE to transmit a carrier wave on different subcarriers during a slot; receives, during the slot: a first compound transmission on a first subcarrier comprising the carrier wave as transmitted by the first UE and a first backscattering generated by a first ambient IoT tag from the carrier wave, and a second compound transmission on the second subcarrier comprising the carrier wave as transmitted by the second UE and a second backscattering generated by a second ambient IoT tag from the carrier wave; and decodes, from the first backscattering and the second backscattering, data of the first ambient IoT tag and the second ambient IoT tag.

### TECHNICAL FIELD

This application relates generally to wireless communication systems, including systems implementing ambient internet of things(IoT) transmission.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers(IEEE) 802.11 standard for Wireless Local Area Networks(WLAN) (commonly known to industry groups as Wi-Fi®).

As contemplated by the 3GPP, different wireless communication systems' standards and protocols can use various radio access networks(RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications(GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies(RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, cNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHZ (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates examples of carrier wave transmission and backscattering.

FIG. 2 illustrates an example of multi-access between a base station and multiple ambient IoT tags, according to embodiments herein.

FIG. 3 illustrates an example of multi-access as between a base station and multiple ambient IoT tags where carrier waves are provided to the ambient IoT tags by various UEs, according to embodiments herein.

FIG. 4 illustrates an example procedure for generating backscatterings of carrier waves at ambient IoT tags, where carrier waves are received from a base station, according to embodiments herein.

FIG. 5 illustrates selecting UL resources from a resource pool and an example procedure for generating backscatterings of carrier waves at lower category ambient IoT tags and a simultaneous use of higher category ambient IoT tags that perform self-powered transmissions according to embodiments herein.

FIG. 6 illustrates an example procedure for generating backscattered carrier waves where the carrier waves are received from a UE or assisting device, according to embodiments herein.

FIG. 7 illustrates an example procedure for generating backscatterings that are both FDM′d and CDM′d and where the ambient IT tags select resources from an ambient IoT resource pool for performing backscatterings, according to embodiments herein.

FIG. 8A illustrates a first example of lower category IoT tag use where interference can affect signaling.

FIG. 8B illustrates a second example of lower category IoT tag use where interference can affect signaling.

FIG. 9 illustrates examples of UL packet formats according to various preamble lengths, according to embodiments herein.

FIG. 10 illustrates examples of UL packet formats with varying preamble lengths using OOK transmission, according to embodiments herein.

FIG. 11 illustrates various examples of DL transmission with a preamble, a signaling field, and a data payload.

FIG. 12 illustrates an example of a preamble design for a carrier wave transmitted by the carrier wave transmitter in the time domain for DL transmission, according to embodiments herein.

FIG. 13 illustrates an example of a preamble design in the frequency domain for DL transmission, according to embodiments herein.

FIG. 14 illustrates a method of a base station, according to embodiments herein.

FIG. 15 illustrates a method of an ambient IoT tag, according to embodiments herein.

FIG. 16 illustrates a method of a base station, according to embodiments herein.

FIG. 17 illustrates a method of a base station, according to embodiments herein.

FIG. 18 illustrates a method of an ambient IoT tag, according to embodiments herein.

FIG. 19 illustrates an example architecture of a wireless communication system, according to embodiments disclosed herein.

FIG. 20 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some wireless communication systems, it may be beneficial to study a harmonized air interface design with minimized differences(where necessary) for ambient internet of things(IoT) to enable various device categories. A first device category may include devices with around 1 μW peak power consumption, having energy storage, having an initial sampling frequency offset (SFO) of up to 10∧X parts-per-million (ppm), and having neither downlink (DL) nor uplink (UL) amplification in the device. For a first category device, the device's UL transmission is backscattered on a carrier wave provided externally. A second device category may include devices with having around less than or equal to a few hundred u W peak power consumption, having energy storage, having an initial SFO of up to 10∧X ppm, and having both DL and UL amplification in the device. For second category devices, the device's UL transmission may be generated internally by the device, or be backscattered on a carrier wave provided externally. Both categories of devices may have a maximum coverage distance of, for example, 10-50 meters with device indoors. Additionally, devices using Topologies 1 and 2 (e.g., a UE as an intermediate node under network control) may have no radio resource control (RRC) states, no mobility (i.e. at least no cell selection/re-selection function), no hybrid automatic repeat request (HARQ), and/or no automatic repeat request (ARQ).

Further, it may be beneficial to discuss various deployment scenarios for such devices. For example, a first deployment scenario with Topology 1 may include a base station and coexistence characteristics (e.g., Micro-cell, co-site). A second deployment scenario with Topology 2 may include a UE as an intermediate node under network control, a base station and coexistence characteristics (e.g., Macro-cell, co-site) The location of the intermediate node may be indoors.

In some wireless communication mechanisms, it may be that there is a FR1 licensed spectrum in frequency division duplex (FDD). The spectrum deployment may be in-band to NR, in guard-band to LTE/NR, and/or in standalone band(s). Traffic types may include device originated-device terminated triggered (DO-DTT) and/or device-terminated (DT) types, with a focus on rUC1 (e.g., indoor inventory) and rUC4 (e.g., indoor command). Further, it may be beneficial to study whether the harmonized air interface design may address the device-originated autonomous (DO-A) use cases, and/or to identify which part(s) of the harmonized air interface design (per bullet ‘A’ above) is/are not sufficient for the DO-A use cases. Transmission(s) from ambient IoT tags (including backscattering when used) may occur at least in the UL spectrum.

Additionally, for the ambient IoT DL and UL transmission(s), it may be beneficial to discuss frame structure, synchronization and timing, random access, numerologies, bandwidths, and multiple access, waveforms and modulations, channel coding, downlink channel/signal aspects, uplink channel/signal aspects, and/or scheduling and timing relationships. Further, it may be beneficial to discuss characteristics of carrier wave waveforms for a carrier wave provided externally to the ambient IoT tag, including for interference handling at an ambient IoT UL receiver, and at the base station. Note that for Topology 2, there may be no difference in physical layer design from the Topology 1 physical layer design.

In some wireless communication systems, to enable lower costs and lower power receivers, waveforms using amplitude modulation (such as on-off keying (OOK)) have been widely used in radio frequency identifier (RFID) design, 802.11 low power wakeup radio, and chosen as candidate waveforms for low power wake up signal (WUS) design.

### Carrier Wave Design and Multiplexing Procedures of Different Ambient IoT Tags

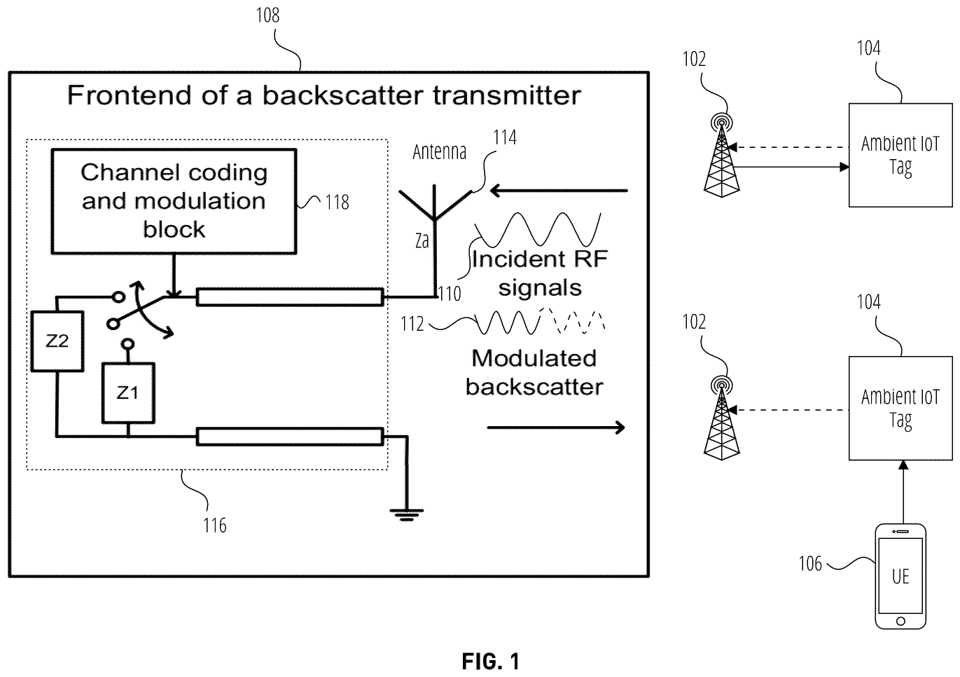

FIG. 1 illustrates examples of carrier wave transmission and backscattering.

In some wireless communication systems, some ambient IoT tags may be operated based on externally provided carrier waves.

In some examples, a base station 102 may transmit a carrier wave to an ambient IoT tag 104 and the ambient IoT tag 104 may backscatter the carrier wave back to the base station 102.

In some other examples, a UE 106 (or any other dedicated assisting device) may transmit a carrier wave to the ambient IoT tag 104 (low category device) and the ambient IoT tag 104 may backscatter the carrier wave to the base station 102.

According to these examples, it should be understood that in some instances, a base station 102 and a UE 106 may provide carrier waves to the ambient IoT tag 104. Further, note that while embodiments herein refer to the use of base station(s) in various scenarios as carrier wave transmitters and/or backscattering receivers (e.g., as has been described in relation to base station 102), it should be understood that base station may encompass a reader device or any other device controlled by the network to perform analogous functions as base stations as described herein.

The ambient IoT tag 104 may receive the carrier wave from the base station 102 and/or the UE 106 and backscatter the carrier wave to the base station 102 using a backscatter transmitter 108. For example, an antenna 114 of the backscatter transmitter 108 may receive an incident RF signal 110 (e.g., the carrier wave) from a base station 102 and/or a UE 106. The antenna 114 of the backscatter transmitter 108 passes the incident RF signal 110 to circuitry 116 of the backscatter transmitter 108. The circuitry 116 to generates the modulated backscatter signal 112 from the incident RF signal 110. As illustrated, the circuitry 116 may include, among other things, a channel coding and modulation block 118 for such purposes. The backscatter transmitter 108 may then output the modulated backscatter signal 112 (e.g., backscattered carrier wave) to the base station 102.

It should be understood that devices of more complex form factors/capability classes than that strictly shown for the ambient IoT tag 104 of FIG. 1 may act as ambient IoT tags as discussed herein. For example, in some cases, an ambient IoT tag may be a relatively complex device that has a backscatter transmitter and and/or is otherwise configured to act as an ambient IoT tag within the system.

As has been shown, the ambient IoT tag 104 represents a category of ambient IoT tag that uses backscattering of a provided carrier wave. Other categories of ambient IoT tags are also discussed herein, including classes of ambient IoT tags that do not use backscattering but that rather generate carrier waves for their transmissions internally.

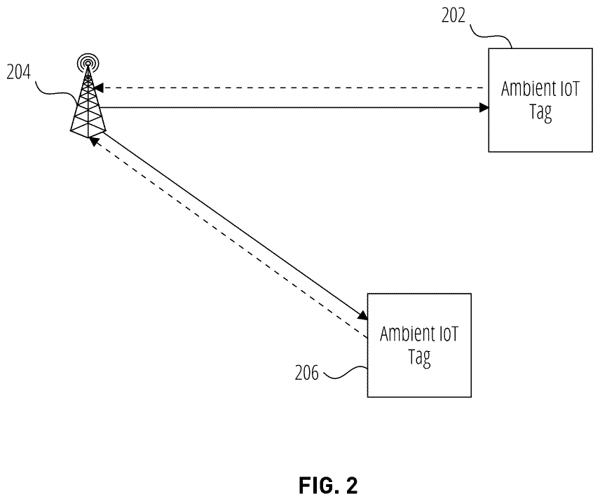

FIG. 2 illustrates an example of multi-access between a base station and multiple ambient IoT tags, according to embodiments herein.

In some embodiments, a base station may read multiple ambient IoT tags at the same time. In some cases, the base station may transmit carrier wave(s) to various IoT tags. For example, the base station 204 may transmit carrier wave(s) to the first ambient IoT tag 202 and/or the second ambient IoT tag 206 and correspondingly receive backscattered waves from the first ambient IoT tag 202 and the second ambient IoT tag 206.

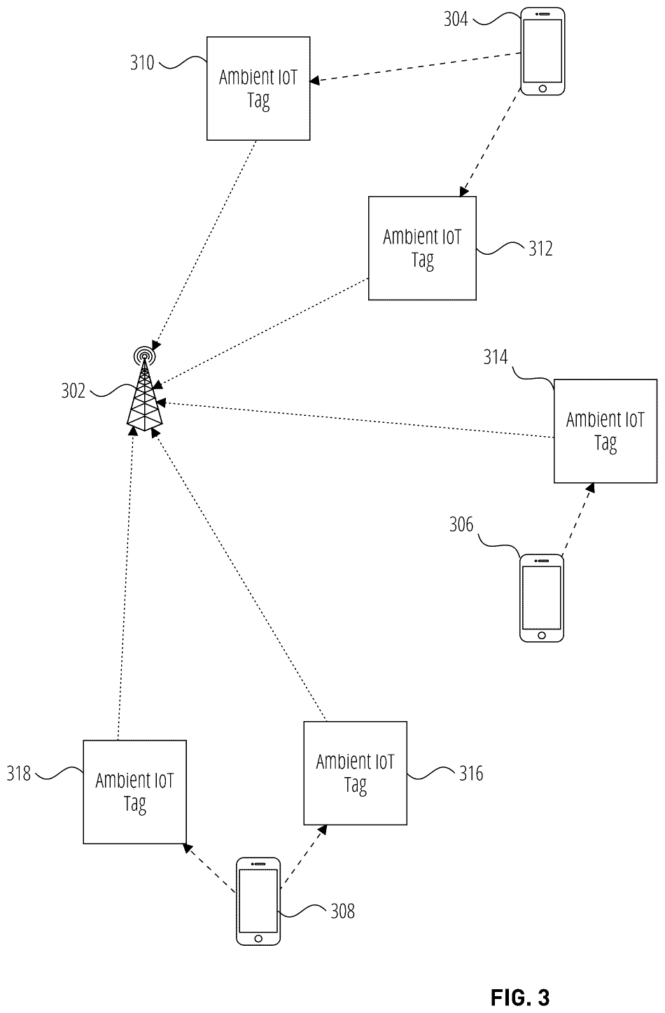

FIG. 3 illustrates an example of multi-access as between a base station and multiple ambient IoT tags where carrier waves are provided to the ambient IoT tags by various UEs, according to embodiments herein.

In some cases, a device other than the base station, such as a UE or a dedicated assisting device, may transmit carrier wave(s) to various IoT tags in combination with or independently of the base station. For example, the first UE 304 may transmit carrier wave(s) to the first ambient IoT tag 310 and the second ambient IoT tag 312. The second UE 306 may transmit carrier wave(s) to the third ambient IoT tag 314. The third UE 308 may transmit carrier wave(s) to the fourth ambient IoT tag 316 and fifth ambient IoT tag 318. The various ambient IoT tags (e.g., first ambient IoT tag 310, second ambient IoT tag 312, third ambient IoT tag 314 and fourth ambient IoT tag 316) may backscatter the carrier wave to the base station 302.

Details for embodiments related to when base stations transmit carrier wave(s) to ambient IoT tags are now discussed.

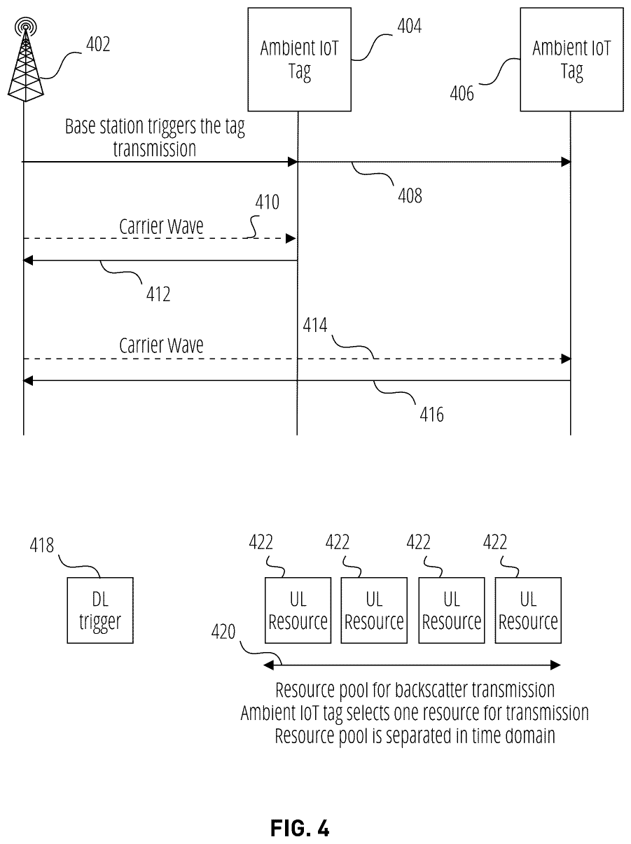

FIG. 4 illustrates an example procedure for generating backscatterings of carrier waves at ambient IoT tags, where carrier waves are received from a base station, according to embodiments herein.

In some embodiments, a triggering packet payload such as a DL trigger packet 418, may indicate a resource pool 420 for sending sensor/tag information. Ambient IoT tags which receive the DL trigger packet 418 may try to use one or more of the UL resources 422 of the resource pool 420 for use in feedback using backscattering as described herein.

In some instances, a DL trigger packet 418 may identify one or multiple ambient IoT tags to feedback in addition to indicating the resource pool 420. Then, the ambient IoT tag(s) that have been polled by the base station may try to randomly select one resource from the indicated resource pool for use in feedback using backscattering as described herein. For example, in the time domain, one resource of a resource pool may be randomly selected by the ambient IoT tag based on the trigger packet payload for generating backscattering from the carrier wave.

In some cases, when the resource pool only contains one resource, and only one ambient IoT tag is requested for transmission, then the ambient IoT tag will transmit on the indicated resource.

In some cases, the DL trigger packet may indicate the resource pool and one or multiple ambient IoT tags to feedback, such that there is a 1:1 mapping relationship of the resources within the resource pool and the IoT tags. In such cases, each IoT tag uses a resource of the resource pool according to the 1:1 mapping.

A procedure for generating backscattered carrier waves begins with a base station 402 triggering 408 an ambient IoT tag transmission by transmitting a trigger packet (e.g., DL trigger packet 418) that identifies an ambient IoT resource pool to the first ambient IoT tag 404 and the second ambient IoT tag 406. Then, the base station 402 transmits 410 a carrier wave in the resource pool 420. The first ambient IoT tag 404 generates a backscattering 412 of the carrier wave that is transmitted back to the base station 402 using resource(s) (e.g., randomly selected resources or indicated resources) of the identified resource pool. The second ambient IoT tag 406 also generates a backscattering 416 of the carrier wave that is transmitted back to the base station 402 using resource(s) (e.g., randomly selected resources or indicated resources) of the identified resource pool.

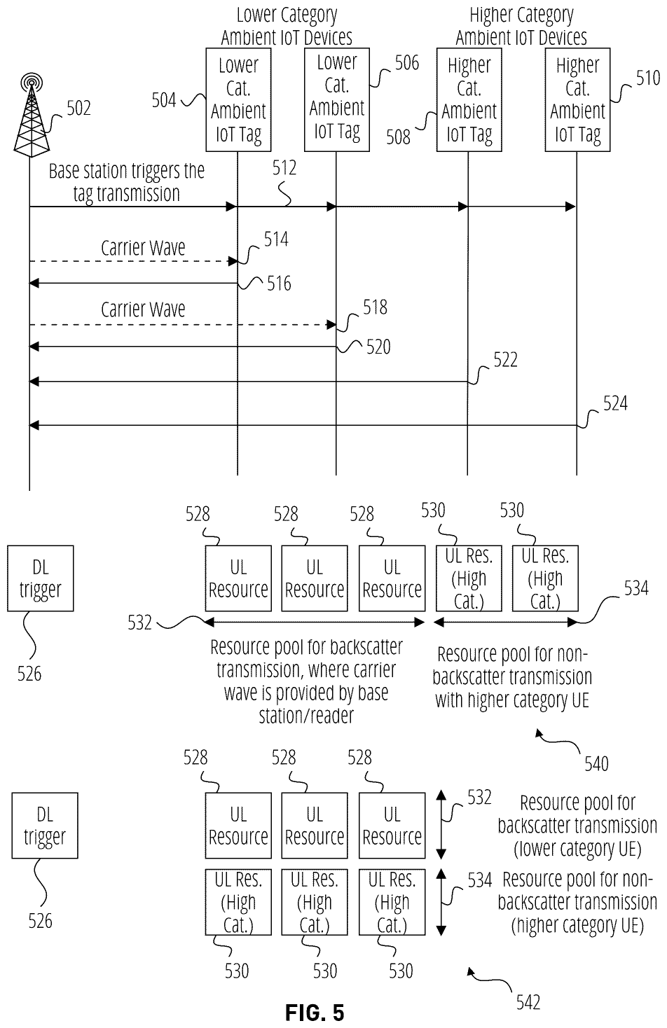

FIG. 5 illustrates selecting UL resources from a resource pool and an example procedure for generating backscatterings of carrier waves at lower category ambient IoT tags and a simultaneous use of higher category ambient IT tags that perform self-powered transmissions according to embodiments herein.

Corresponding to cases where an ambient IoT tag selects a resource from an ambient IoT resource pool, a corresponding DL trigger transmission may begin with a time synchronization preamble that enables the ambient IoT tag to perform symbol timing acquisition and sampling time acquisition. An UL transmission performed by the ambient IoT tag may then follow the timing of the DL trigger as transmitted by the base station.

Embodiments herein may refer to two categories of ambient IoT tags. A lower category ambient IoT tag may perform a backscattering of an external carrier wave to transmit data, whereas a higher category ambient IoT tag may transmit a signal without so receiving/using an external carrier wave.

In some instances, individual resource pools for each category of ambient IoT tag may be used for UL resource selection. For example, a lower category ambient IoT tag may select one or more of the UL resources 528 of a resource pool for lower category ambient IoT tags 532 to use to perform backscattering, while a higher category ambient IoT tag may select one or more of the UL resources 530 from a resource pool for higher category ambient IoT tags 534 to perform its transmission.

In first cases 540, the resource pool for lower category ambient IoT tags 532 and a resource pool for higher category ambient IoT tags 534 are separated in the time domain. The carrier wave is accordingly transmitted only at times for the resource pool for lower category ambient IoT tags 532).

In second cases 542, the resource pool for lower category ambient IoT tags 532 and the resource pool for higher category ambient IoT tags 534 overlap in the time domain, as illustrated. In some such instances, the carrier wave that is used by lower category ambient IoT tags for backscattering is transmitted using a one tone waveform corresponding to a frequency of the resource pool for lower category ambient IoT tags 532. It may be that configuration information for the resource pool for higher category ambient IoT tags 534 as used by the higher category ambient IoT tags includes both the time domain resource information for the resource pool for higher category ambient IoT tags 534 plus candidate frequency domain information indicating one or more tones that the higher category ambient IoT tags can use for their transmissions in that resource pool (and that are tones other than that used for a carrier wave used in the resource pool for lower category ambient IoT tags 532 for the lower category ambient IoT tags). The higher category ambient IoT tags use the indicated tones for their transmissions, with the result that these transmissions are differentiable on a frequency basis from the backscattering signals of the lower category ambient IoT tags.

In some other instances, a carrier wave that is used by lower category ambient IoT tags for backscattering is transmitted using a multi-tone waveform where the frequency domain sequence is chosen by the base station. It may be that configuration information for the higher category ambient IoT tag resource pool as used by the higher category ambient IoT tags includes time domain resource information for that higher category ambient IoT tag resource pool plus candidate frequency domain sequences. However, in such instances, the one or more sequences that the higher category ambient IoT tags can use for their transmissions in that resource pool may be chosen by the base station (and are sequences other than/that do not overlap with sequences used for a carrier wave used in the lower category ambient IoT tag resource pool for the lower category ambient IoT tags). The higher category ambient IoT tags use the chosen sequences (as chosen by the base station) for their transmissions, with the result that these transmissions are differentiable on a frequency basis from the backscattering signals of the lower category ambient IoT tag.

An example procedure for generating backscattered carrier waves at lower category ambient IoT tags and transmitting signals at higher category ambient IoT tags begins with the base station 502 sending 512 a DL trigger packet 526 to the ambient IoT tags. Then, the base station 502 transmits 514 a carrier wave in the resource pool for lower category ambient IoT tags 532. Accordingly, the first lower category ambient IoT tag 504 generates a backscattering 516 of the carrier wave for transmission back to the base station 502 using resource(s) (e.g., randomly selected resources or indicated resources) from the resource pool for lower category ambient IoT tags 532. Further, the second lower category ambient IoT tag 506 generates a backscattering 520 of the carrier wave for transmission back to the base station 502 using (e.g., using randomly selected) resource(s) from the resource pool for lower category ambient IoT tags 532.

Still further, the first higher category ambient IoT tag 508 transmits 522 data to the base station 502 using resource(s) (e.g., randomly selected resources or indicated resources) of the resource pool for higher category ambient IoT tags 534 and the second higher category ambient IoT tag 510 transmits 524 data to the base station 502 using resource(s) (e.g., randomly selected resources or indicated resources) of the resource pool for higher category ambient IoT tags 534. Note that first higher category ambient IoT tag 508 and the second higher category ambient IoT tag 510 do not need to receive a carrier wave from the base station 502 as higher category independently generate their transmissions(instead of relying on backscattering).

Details for embodiments where a UE or another dedicated assisting device transmits the carrier wave(s) for use by various ambient IoT tags are now discussed.

In some embodiments, different ambient IoT tags may backscatter carrier waves from different UEs and/or assisting devices. Corresponding to such cases, each carrier wave may be configured to carry a signature that ultimately enables multiple access at the base station, as will be described.

In some cases, received backscattered carrier waves from the ambient IoT tags may be frequency division multiplexed (FDM′d) together. In one such example, a carrier wave of a single, same tone may be used by each assisting device that transmits the carrier wave. However, each assisting device may be instructed to perform the transmission using a separate subcarrier within that tone. Accordingly, as the different ambient IoT tags backscatter the various carrier waves from the various UEs/assisting devices, and the received backscatterings of any given time resource are FDM′d together from the perspective of the base station.

The base station may schedule the assisting device or UE to transmit a carrier wave on an UL frequency of the FDD band. In some instances, the scheduling may be based on a UE specific downlink control information (DCI), where the base station may send a first DCI to schedule a first UE to transmit the carrier wave at a first subcarrier of the carrier wave configuration. A second DCI may be used to schedule a second UE to transmit a carrier wave at a second subcarrier of the carrier wave configuration, with no constraint with respect to when any assisting device can be scheduled to transmit a carrier wave such that the schedules may overlap in time.

In some other instances, a group DCI may be used. For example, a base station may send one DCI that schedules both the first UE and the second UE to transmit the carrier wave at different subcarriers of the carrier wave configuration, with no constraint with respect to when any assisting device can be scheduled to transmit a carrier wave such that the schedules may overlap in time.

FDM-ing occurs because the base station uses the DCI (e.g., UE specific or group) to instruct each UE to use a different subcarrier within the overall carrier wave configuration. As such, any jointly received backscatterings are received on different subcarriers in an FDM fashion. Accordingly, the base station is enabled to decode such signals from each other.

In some other cases, received backscattered carrier waves from the ambient IoT tags may be code division multiplexed (CDM′d) together. For example, it may be that each UE transmits different sequences in the frequency domain. Then, as various ambient IoT tags use a same time to resource backscatter different carrier waves various different UEs, the received signal at the base station are accordingly CDM′d such that the base station may decode such signals (due to sequence orthogonality).

To facilitate this CDM-ing, the base station may schedule each assisting device to transmit a carrier wave on a UL frequency of the FDD band. In some instances, UE-specific DCI for each of the assisting devices may be used for such scheduling. For example, the base station may send a first DCI that schedules the first UE to transmit the carrier wave using a first sequence and a second DCI that schedules a second UE to transmit the carrier wave using a second sequence, with no constraint with respect to when any assisting device can be scheduled to transmit a carrier wave such that the schedules may overlap in time.

In some other instances, a group DCI may be used. For example, a base station may send one DCI that schedules each of a first UE and a second UE to transmit the carrier wave, but with different sequences, with no constraint with respect to when any assisting device can be scheduled to transmit a carrier wave such that the schedules may overlap in time.

CDM-ing occurs because the base station uses the DCI (e.g., UE specific or group) to instruct each UE to use a different sequence in the frequency domain. As such, any jointly received backscatterings are received in a CDM fashion due to the use of the different sequences. Accordingly, the base station is enabled to decode such signals from each other.

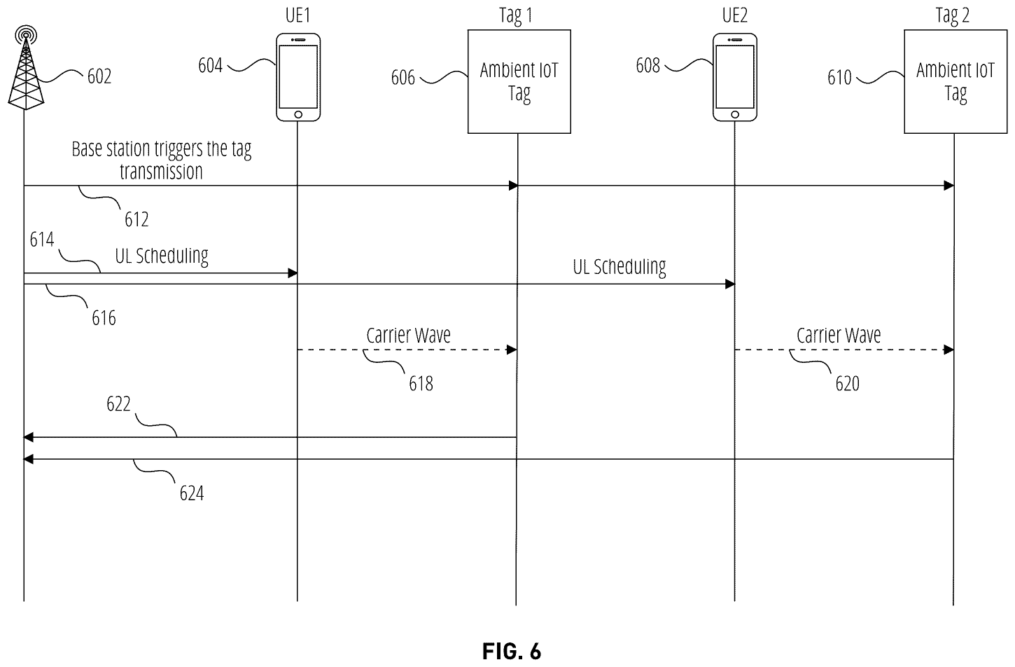

FIG. 6 illustrates an example procedure for generating backscattered carrier waves where the carrier waves are received from a UE or assisting device, according to embodiments herein.

The procedure begins with the base station 602 triggering 612 ambient IoT tag transmission as discussed herein (e.g., using a DL trigger packet). Then, the base station 602 transmits 614 UL scheduling to the first UE 604 (e.g., using a UE specific DCI for the first UE 604 or a group DCI, as discussed herein) and transmits 616 UL scheduling to the second UE 608 (e.g., using a UE specific DCI for the second UE 608 or a group DCI, as discussed herein). Based on its receipt of UL scheduling, the first UE 604 transmits 618 a first carrier wave to the first ambient IoT tag 606. Further, based on its receipt of UL scheduling, the second UE 608 transmits 620 a second carrier wave to the second ambient IoT tag 610.

As has been described, in FDM-based cases, the first UE 604 may use a first subcarrier for its transmission of the first carrier wave, while the second UE 608 may use a second subcarrier for its transmission of the second carrier wave. Further, in CDM-based cases, the first UE 604 may use a first sequence in the frequency domain for its transmission of the first carrier wave, while the second UE 608 may use a second sequence in the frequency domain for its transmission of the second carrier wave.

Accordingly, the first ambient IoT tag 606 generates a backscattering 622 of the first carrier wave for transmission back to the base station 602 (e.g., using randomly selected resources of a resource pool indicated in the DL trigger packet). Further, the second ambient IoT tag 610 generates a backscattering 624 of the second carrier wave for transmission back to the base station 602 (e.g., using randomly selected resources of a resource pool indicated in the DL trigger packet).

It should be understood that if the base station 602 receives the backscatterings at the same time, it can leverage the FDM-ing and/or the CDM-ing (as the case may be) to make sense of the jointly received backscatterings.

In some embodiments a combination of the cases discussed herein may be used where the received backscatterings may be both FDM′d and CDM′d, and further where selection within an ambient IoT resource pool is used by the receiving ambient IoT tags. The base station may schedule the UE or assisting devices to transmit carrier waves on a UL frequency of the FDD band. In some instances, a UE specific DCI may be used. For example, a base station may send a first DCI to schedule the first UE or assisting device to transmit a carrier wave at a first subcarrier of the carrier wave configuration and/or using one specific CDM code and may send a second DCI to schedule the second UE or assisting device to transmit a carrier wave at a second subcarrier of the carrier wave configuration and/or using another, different specific CDM code. Such a UE specific DCI may schedule multiple time slots over a resource pool for ambient IoT tags to select.

In some other instances, a group DCI may be used. For example, a base station may send one DCI that schedules each of the first UE or assisting device and the second UE or assisting device to transmit carrier waves according to different subcarriers of the carrier wave configuration and/or different CDM codes. For example, a base station may send one DCI to schedule the first UE or assisting device and the second UE or assisting device to transmit the carrier wave at different subcarriers of the carrier wave configuration and or different CDM codes, with no constraint with respect to when any assisting device can be scheduled to transmit a carrier wave such that the schedules may overlap in time.

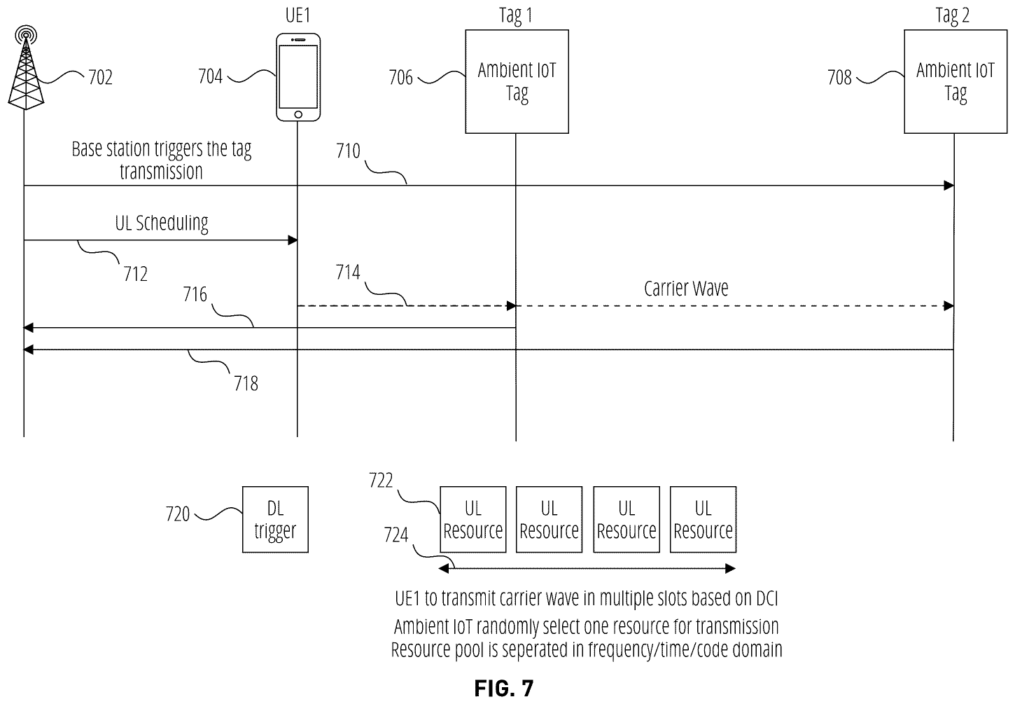

FIG. 7 illustrates an example procedure for generating backscatterings that are both FDM′d and CDM′d and where the ambient IoT tags select resources from an ambient IoT resource pool for performing backscatterings, according to embodiments herein.

For example, a procedure for generating backscatterings that are both are FDM′d and CDM′d begins with the base station 702 triggering 710 the ambient IoT tag transmission using a DL trigger packet 720. The base station 702 transmits 712 UL scheduling to the first UE 704 (e.g., using UE specific DCI or group DCI). Based on the UL scheduling, the first UE 704 transmits 714 a carrier wave to the first ambient IoT tag 706 and the second ambient IoT tag 708. The carrier wave may be transmitted in multiple slots of a corresponding resource pool 724.

Accordingly, the first ambient IoT tag 706 generates a backscattering 716 of the carrier wave for transmission to the base station 702 and the second ambient IoT tag 708 generates a backscattering 718 of the carrier wave for transmission back to the base station 702. To accomplish this, the first ambient IoT tag 706 and the second ambient IoT tag 708 may each select one UL resource 722 (e.g., randomly, or as indicated) for transmission from a resource pool 724 of UL resources 722.

Accordingly, it is contemplated that the backscatterings could be performed/arrive at the base station in a same time resource. In such cases, the base station 702 may leverage the effective FDM-ing and/or the CDM-ing of the backscatterings to differentiate the signals. Accordingly, it may be understood generally that the use of the resource pool 724 occurs according to potential separation(s) in any one or more of the frequency domain, the time domain, and/or the code/sequence domain, as has been described herein.

It should be noted while various examples herein expressly illustrate only the use of lower category ambient IoT tags that use backscattering of a carrier wave, it could be the case that higher category ambient IoT tags (unillustrated) are also active in such embodiments. It will be understood generally that where, a higher category ambient IoT tags are also scheduled to perform transmissions in such cases, those transmissions may be configured to be orthogonal to any carrier wave (and any backscattering performed by any lower category ambient IoT tag using that carrier wave) in at least one of a time domain, a frequency domain, and/or a code/sequence domain (e.g., through the use of a separate resource pool configuration that is orthogonal to a resource pool for the lower category ambient IoT tags).

Embodiments herein refer to multiple access schemes. Further, embodiments herein refer to random access procedures. For example, from the perspective of the physical layer, at least when a response is expected from multiple devices that are intended to be identified, an ambient IoT contention-based access procedure initiated by the reader is used, for which at least slotted-ALOHA based access and FDMA, are studied. The study of FDMA includes how the frequency domain resources for Msg1 are allocated, and how a device determines that frequency-domain resource allocation. The response transmitted from the device to the reader during this procedure is transmitted on the physical device-to-reader control channel (PDRCH). A reader-to-device (R2D) transmission triggering random access determines X time domain resource(s) for device-to-reader (D2R) transmission(s) for Msg1, where each D2R transmission for Msg1 occurs in one time domain resource of the X time domain resource(s). It may be beneficial to study values of X such that X=1 and X>1 and X>=1. The maximum value of X>1 should be set considering the device implementation complexity, device power consumption, the resource usage efficiency affected at least by SFO, and inventory latency. Further, it may be beneficial to study size(s) for resource allocation in the time domain, a determination of the X time domain resource(s) by the device, and addressing timing errors for adjacent time domain resources due to residual SFO of the device.

For Msg2 transmission in response to multiple Msg1 transmissions initiated by a R2D transmission triggering random access, it may be beneficial to study various examples. In one example, a physical reader-to-device control channel (PRDCH) for Msg2 transmission corresponds to an ambient IoT Msg1 received from one device. In a second example, a PRDCH for Msg2 transmission corresponds to multiple ambient IoT Msg1 received from different devices.

For Msg3 from multiple devices in response to a given set of one or multiple Msg2 transmission(s) during access procedure, FDMA and/or TDMA of D2R transmissions may be studied, including how the frequency and time domain resources for Msg3 are allocated. Further, it may be beneficial to study the starting time and time duration for Msg2 monitoring for Msg2 reception.

Additionally embodiments herein refer to various carrier waves. For example, the various carrier wave waveform characteristics which may control the carrier wave node(s)/assisting device(s) may be identified such as when the carrier wave is transmitted or not transmitted, the transmission power, frequency resources, e.g. frequency location(s) for a waveform (e.g., a first waveform, or a second waveform). Other carrier wave waveform characteristics which would need control of the carrier wave node(s)/assisting device(s), if any, may be further studied.

### Interference Mitigation and Channel Estimation Methods For Backscattered Ambient IoT Transmission

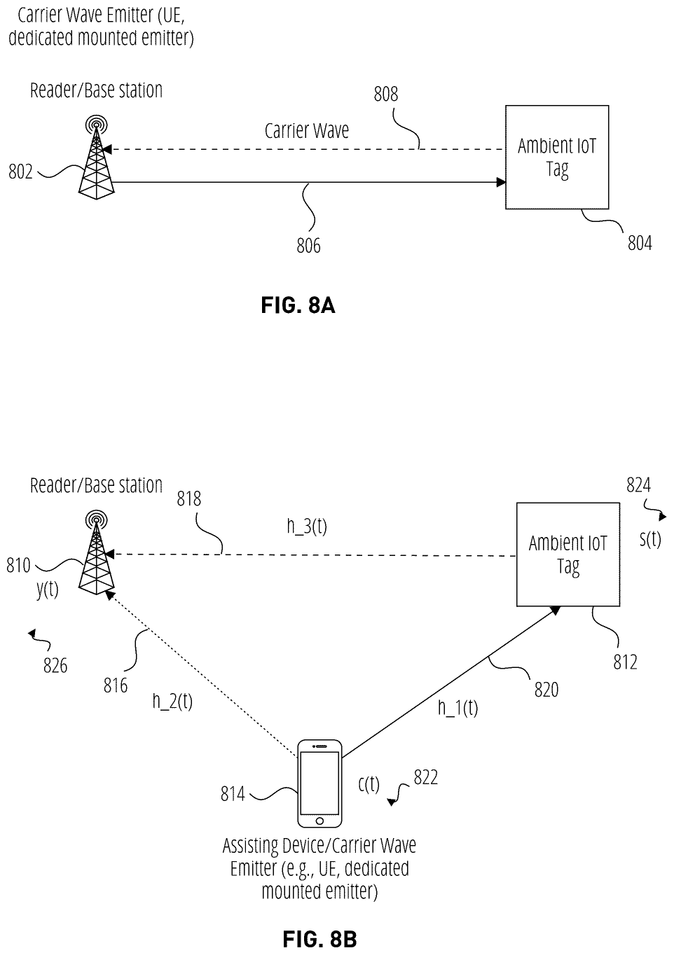

FIG. 8A illustrates a first example of lower category IoT tag use where interference can affect signaling.

As discussed herein, for at least some lower category ambient IoT tags, a carrier wave is provided externally to enable backscattering operations. The carrier wave can be transmitted by a base station to the lower category ambient IoT tag. This results in full duplex receiving. The base station may need to cancel the carrier wave (e.g., by implementation) as the base station is acting as both the source of the carrier wave and the destination of the backscattered carrier wave.

For example, a base station 802 transmits 806 a carrier wave to an ambient IoT tag 804. Accordingly, the ambient IoT tag 804 backscatters 808 the transmitted carrier wave back to the base station 802. As such, the base station 802 may need to cancel the carrier wave as the base station 802 acts as both the source of the carrier wave and the destination of the backscattered carrier wave (as backscattered by the ambient IoT tag 804).

FIG. 8B illustrates a second example of lower category IoT tag use where interference can affect signaling.

In some cases, a base station 810 acts as a reader of a modulated carrier wave (a backscattering) from an ambient IoT tag 812 of a carrier wave that is initially transmitted by an assisting device 814 (such as an assisting device as discussed herein).

Various channels that exist corresponding to such cases may be discussed herein. For example, as illustrated in FIG. 8B, a channel h_1(t) 820 used by the modulated carrier wave runs between an assisting device 814 and the ambient IoT tag 812. Further, a channel h_2(t) 816 used by the carrier wave runs between an assisting device 814 and the base station 810. Finally, a channel h_3(t) 818 used by the carrier wave runs between the ambient IoT tag 812 and the base station 810.

In such cases, the base station 810 receives an unmodulated carrier wave from the assisting device 814 on the channel h_2(t) 816 jointly with the modulated carrier wave from the ambient IoT tag 812 on channel h_3(t) 818. In general terms, if the carrier wave transmitted by the assisting device 814 is a signal c(t) 822 and a corresponding backscattering of the ambient IoT tag 812 is a signal s(t) 824 it may be understood that, per the system model, a received signal y(t) 826 at the base stations includes both the signal c(t) 822 and the signal s(t) 824. Thus, the signal c(t) 822 sourced from the assisting device 814 as received over the channel h_2(t) 816 represents an interference to the reception of the signal s(t) 824 from the ambient IoT tag 812 at the base station. Note also that, according to this model, the signaling along the channel h_1(t) 820 does not contribute to this interference.

In sum, an interference condition occurs as the base station 810 jointly receives both the carrier wave (signal c(t) 822) from the assisting device 814 on the channel h_2(t) 816 and the backscattering of that same carrier wave (signal s(t) 824) from the ambient IoT tag 812 on the channel h_3(t) 818.

Further, it is noted that, in many cases, the interference portion (signal c(t) 822 on channel h_2(t) 816) may be stronger than the desired signal (signal s(t) 824 on channel h_3(t) 818) due to, various factors. A first factor may be, for example, “double” path loss associated with the nature of the signal s(t) 824. As the signal s(t) 824 is a backscattering of the signal c(t) 822 along channel h_1(t) 820, the signal s(t) 824 as perceived at the base station 810 ultimately suffers path loss along each of channel h_1(t) 820 and channel h_3(t) 818. This is compared to the signal c(t) 822 as received at the base station 802, which only suffers “single” path loss along the channel h_2(t) 816.

A second factor may be that a reflecting/backscattering efficiency of the ambient IoT tag 812 is not ideal (e.g., where 1 represents a perfectly efficient reflection/backscattering real-world results are typically somewhere between (0, 1)).

Embodiments herein introduce details for interference handling due to carrier wave transmission. Such embodiments may apply to cases where multiple assisting devices transmit carrier waves to one or more ambient IoT tags.

Embodiments herein describe designs for preamble transmissions (e.g., time domain orthogonal code designs) that facilitate signal estimation for purposes of interference reduction. Corresponding to such cases, interference can be determined according to the mathematical framework discussed in FIG. 8B. Then, based on preamble design, the base station/reader may estimate channel h_2(t), as will be described. Accordingly, after the estimate of the channel h_2(t) is determined, the base station may subtract estimated interference from the total received signal according to y(t)-c(t)*h_2(t).

Various transmission formats used for purposes of facilitating the interference estimation are proposed. It may be that an assisting device transmits a same carrier wave over a period of time. The transmission may be triggered by base station/reader scheduling, as has been discussed herein. Dynamic scheduling or configured scheduling can be used to schedule this transmission, as the case may be. An example of a time domain sequence transmitted by the assisting device (or an equivalent) may be [1 1 1 1.].

Turning to the corresponding backscattering generated by an ambient IoT tag, it may be understood that a first few symbols of the carrier wave are to be considered as a preamble that the ambient IoT tag can modulate for purposes of facilitating the channel estimation for both interference and data demodulation purposes. More specifically, the ambient IoT tag may implement a time domain orthogonal code with/onto these first few preamble symbols of the carrier wave as received from the assisting device.

In some embodiments, OOK modulation is used by the ambient IoT tag to modulate the preamble symbols of the carrier wave. One example of a sequence format that may be applied to the preamble symbols of the carrier wave by the ambient IoT tag in an OOK case is [1 0] (corresponding to a case where two symbols used for preamble). Another example of a sequence format that is applied to the preamble symbols of the carrier wave by the ambient IoT tag may be [1 1 0 0] (corresponding to a case where four symbols are used for preamble).

In another example, if phase information is used, a sequence format that is applied to these first few symbols by the ambient IoT tag may be [1-1] (2 symbol preamble) or [1 1-1-1] (four symbol preamble), etcetera.

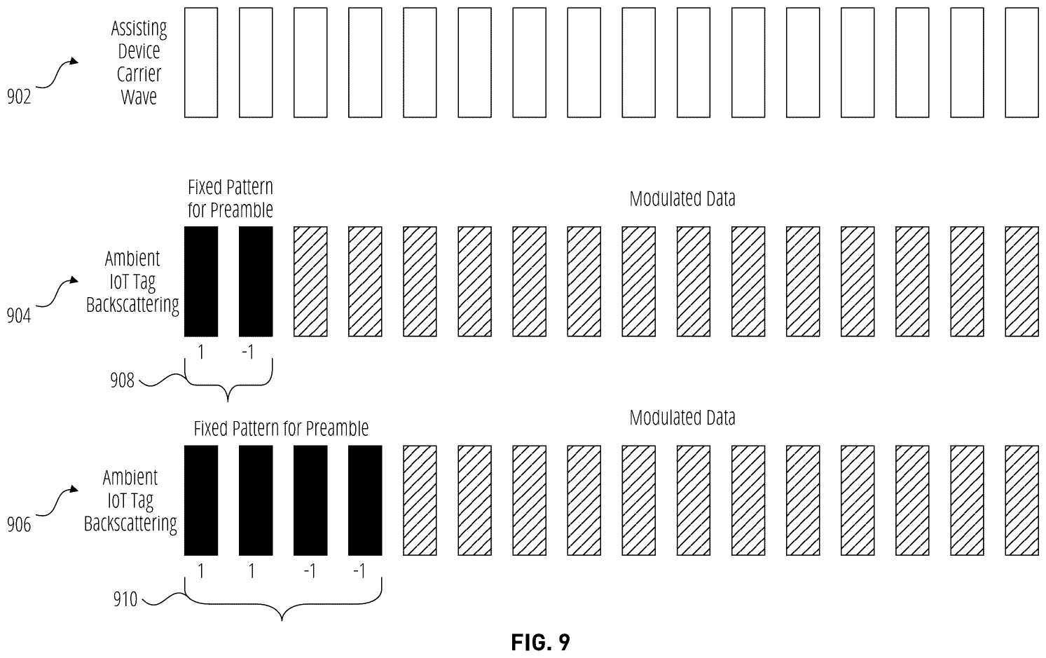

FIG. 9 illustrates examples of UL packet formats according to various preamble lengths, according to embodiments herein.

As has been discussed, a UL transmission as understood/received by a reader/base station may begin with UL packets that correspond to a preamble of a carrier wave (e.g., the first a few symbols are designed/reserved as a preamble). The base station may accordingly understand that these UL packets are a preamble that has been orthogonally modulated according to a fixed pattern by the ambient IoT tag.

Note that various lengths (e.g., number of symbols) may be used for the preamble such as a length 2 symbol preamble or a length 4 symbol preamble. For example, a backscattering 904 of a carrier wave 902 may include a two symbol preamble 908 including a first packet that is modulated with a phase of 1 and a second packet that is modulated with a phase of −1. The rest of the UL packet format includes modulated data that is superimposed on the carrier wave 902 by the ambient IoT tag.

In another example, a backscattering 906 may include a four symbol preamble 910 including a first packet with a value of 1, a second packet with a value of 1, a third packet with a value of −1, and a fourth packet with a value of −1. The rest of the UL packet format includes modulated data that is superimposed on the carrier wave 902 by the ambient IoT tag.

In cases like those under discussion, where a phase based modulation is used by the ambient IoT tag to modulate the carrier wave 902 corresponding to preamble symbols, an estimate of a channel h_2(t) (the channel between the assisting device and the base station) can be generated by the base station by adding symbols of the preamble together and then normalizing the result. Due to the orthogonal modulation that was performed by the ambient IoT tag on these symbols, this addition cancels the signaling portions of these UL packets that are attributable to the channel h_3(t) (the channel between the ambient IoT tag and the base station/reader) on those symbols, leaving only information corresponding to the channel h_2(t). The normalization accounts for the fact that multiple UL packets contributed to the non-normalized result but that the estimate of h_2(t) is needed on a single UL packet basis. Note that this process assumes no changes to the various channels between the entities for the duration of the preamble.

In such examples, the base station may determine an estimate of the channel h_2(t) (the channel between the base station/reader and the assisting device) by normalizing the result of the sum of the symbols of the preamble. For a two symbol preamble, y(1) (the first symbol of the preamble) and y(2) (the second symbol of the preamble) may be added together and normalized. As such, the estimate of channel h_2 is equal to (y(1)+y(2))/2. For a four symbol preamble, y((1) (the first symbol of the preamble), y(2) (the second symbol of the preamble), y(3) (the third symbol of the preamble), and y(4) (the fourth symbol of the preamble) may be added together and normalized. As such, the estimate of channel h_2 is equal to (y(1)+y(2)+y(3)+y(4))/4.

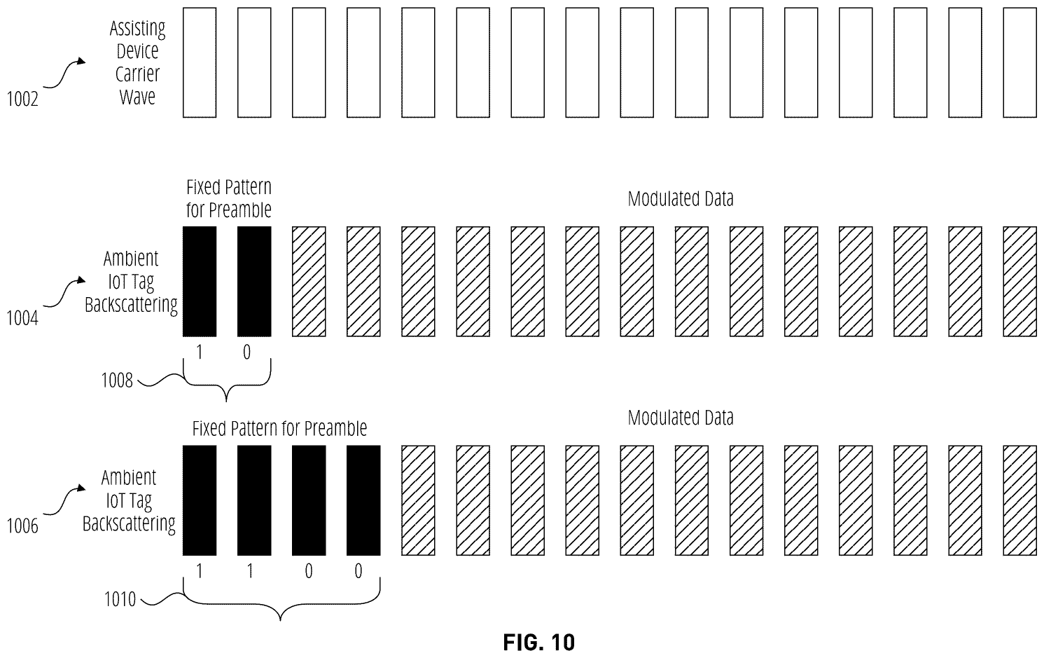

FIG. 10 illustrates examples of UL packet formats with varying preamble lengths using OOK transmission, according to embodiments herein.

In some cases, an OOK transmission may be used. For example, to estimate channel h_2(t) (the channel between the base station and the assisting device), the base station may measure the received signal of known symbol(s) where the ambient IoT tag does not perform any backscattering (“0” value symbols as discussed herein). As a result, any signal read by the base station during such “0” value symbols received may be directly attributable to the channel h_2(t) (the channel between the base station and the assisting device). Note that this process assumes no changes to the various channels between the entities for the duration of the preamble.

In such examples, for a backscattering 1004 with a two symbol preamble 1008, the reader may estimate the channel h_2(t) (channel between the base station and the assisting device) based on the value “0” symbols of the backscattering 1004 of the carrier wave 1002. That is, the channel estimate h_2(t) is equal to the second symbol (y(2)) of the backscattering 1004.

For a backscattering 1006 with a four symbol preamble 1010, the reader may estimate the channel h_2(t) (channel between the base station and the assisting device) based on the value “0” symbols of the backscattering 1006 of the carrier wave 1002. That is, the channel estimate h_2 is equal to the third symbol (y(3)) normalized with the fourth symbol (y(4)). As such the channel estimate may be denoted h_2(t)=(y(3)+y(4))/2. The normalization accounts for the fact that multiple UL packets contributed to the non-normalized result but that the estimate of h_2(t) is needed on a single UL packet basis.

Note that unlike the preamble design in for DL transmission where a longer preamble may be introduced to provide time/sampling synchronization for the entire message exchange, the UL preamble in these cases may mainly be intended for use in interference estimation and cancellation. The base station may also use coherent detection for information decoding.

In some embodiments, different arrangements for causing orthogonal sequences may be used. For example, in some cases, the carrier wave itself can be modulated with fixed time domain sequence (instead of all Is, the transmit pattern may take the form of [1-11-1]). Then, an ambient IoT tag may perform backscattering on a preamble portion of the carrier wave such that the modulated waveform as received at the reader is/remaining orthogonal (such as, for the example carrier wave transmit pattern just provided, backscattering using the phase sequence [1 1 1 1]).

Embodiments herein may refer to a D2R timing acquisition signal. For example, a D2R timing acquisition signal (D-TAS), preceding each PDRCH, may be included at least for timing acquisition, indicating the start of the D2R transmission in the time domain, and may be studied potentially for SFO estimation, carrier frequency offset (CFO) estimation, channel estimation, and interference estimation. It may be beneficial to study the D-TAS structure using a preamble for which a binary signal is considered. The preamble is not part of the PDRCH.

Embodiments herein refer to various characteristics of carrier wave waveforms. For example, case 1-4, case 2-3 and case 2-4 provided below detail various wave form characteristics to may be beneficial to further study.

In a case 1-4, it may be that:
There is no need for base station support of full-duplex capability in UL spectrum;
Spatial isolation is possible, reducing the received carrier wave interference power at a base station side;
Cross-link interference handing for carrier wave can occur at the base station side;
Ae estimation of carrier wave interference may be useful for successful D2R reception at the base station; and
A lower carrier wave transmission power can be assumed in the UL spectrum than that of in the DL spectrum.

In a case 2-3, it may be that:
There is no need for an intermediate UE to support full-duplex capability in DL spectrum;
Spatial isolation is possible, reducing the received carrier wave interference power at the intermediate UE side;
Cross-link interference handling for a carrier wave at can occur at the intermediate UE side;
An estimation of carrier wave interference may be useful for successful D2R reception at the intermediate UE; and
A higher carrier wave transmission power can be assumed in the DL spectrum than that of in the UL spectrum.

In a case 2-4, it may be that:
There is no need for an intermediate UE to support full-duplex capability in UL spectrum;
Spatial isolation is possible, reducing the received carrier wave interference power at the intermediate UE side;
Cross-link interference handling for carrier wave can occur at the intermediate UE side;
An estimation of carrier wave interference may be needed for successful D2R reception at the intermediate UE; and
A lower carrier wave transmission power can be assumed in the UL spectrum than that of in the DL spectrum.

### Downlink Synchronization Preamble Design and Transmission Format for Ambient IoT Transmission(s) Using OOK Waveform(s)

Embodiments herein consider various parameters for transmission sampling. For example, an initial sampling offset may be large (e.g., a 10-5 ppm sampling offset). Further, embodiments herein may have no RRC state requirements. As a result, the UE is not expected to stay in an RRC_CONNECTED mode (e.g., be connected) in between transmissions. For example, the UE is not expected to maintain timing/frequency synchronization as in an RRC_CONNECTED mode.

Embodiments herein introduce DL preamble design that enables synchronization according to a physical layer protocol data unit (PPDU) transmission. In some cases, the frame/slot structure for ambient IoT design with OOK waveforms may include a PPDU transmission format, a preamble, a signaling field indicating a transmission length, and/or a PPDU payload. The preamble design may include a fast automatic gain control (AGC) convergence, a symbol timing sync, and may carry information for high category devices and low category devices.

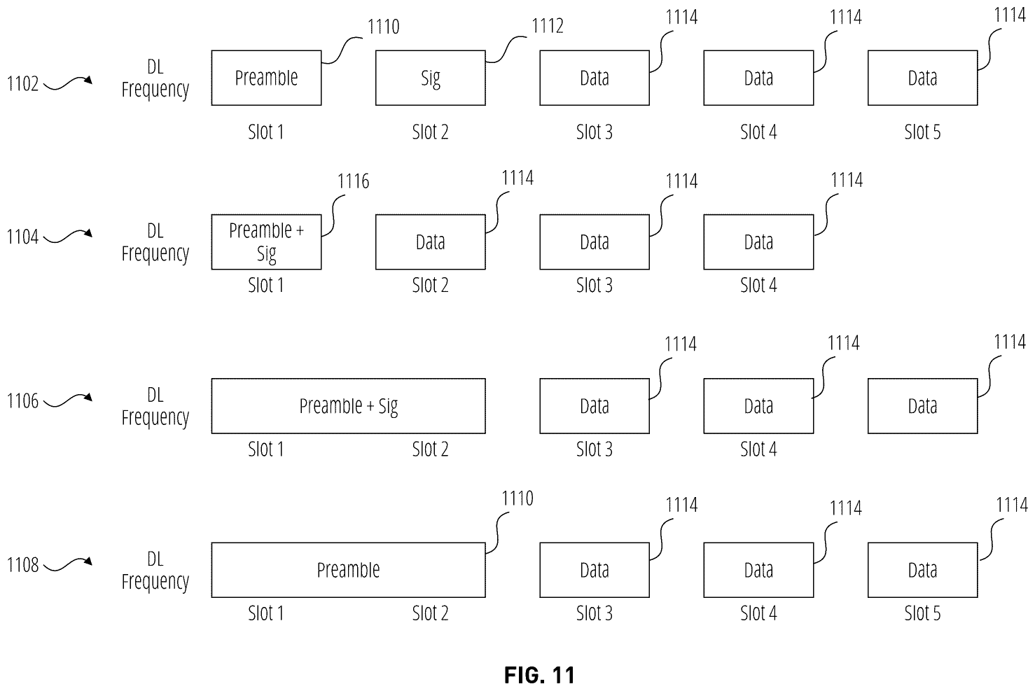

FIG. 11 illustrates various examples of DL transmission with a preamble, a signaling field, and a data payload.

Embodiments herein may refer to amplitude modulation for low power low cost receivers, using OOK. OOK signals may be generated using orthogonal frequency division multiplexed (OFDM) waveforms and the OOK symbol may be equivalent to one OFDM symbol. The OOK symbol length may be shorter or longer, based on OFDM subcarrier spacing. In some instances, a preamble design may use a time domain sequence (e.g., the sequence modulated per OOK symbol in time domain). In addition, to generate OOK symbol(s), a sequence in the frequency domain per OFDM symbol may be used to enhance performance for higher category ambient IoT tags.

In some embodiments, a DL transmission may include a preamble, a signaling field, and a data payload. In a first example 1102, the DL transmission may include a preamble 1110, a signaling field 1112, and three data payload 1114 slots. In a second example 1104, the DL transmission may include a first slot with a preamble and signaling field 1116, and three data payload 1114 slots. In a third example 1106, the DL transmission may include a preamble and signaling field 1116 spanning two slots, and three data payload 1114 slots. In a fourth example 1108, the DL transmission may include a preamble 1110 spanning two slots and three data payload 1114 slots. Note that the fourth example 1108 does not include a signaling field. As such, it may be used in cases where a signaling field is not needed, such as at the end of a packet detection procedure.

In some cases, the preamble 1110 may represent a time domain sequence as modulated on each OOK symbol (e.g., an OFDM symbol if generated using an OFDM waveform as in-band transmission). The signaling field 1112 indicates a length of data in bytes. The signaling field 1112 may also indicate the modulation format of data, if a different modulation is used (e.g., phase is used on top of amplitude for higher data rate transmission). In some instances, if only a limited amount of information (such as one bit, or two bit) is required, the information can be carried by the sequence itself (e.g., by the DL transmission).

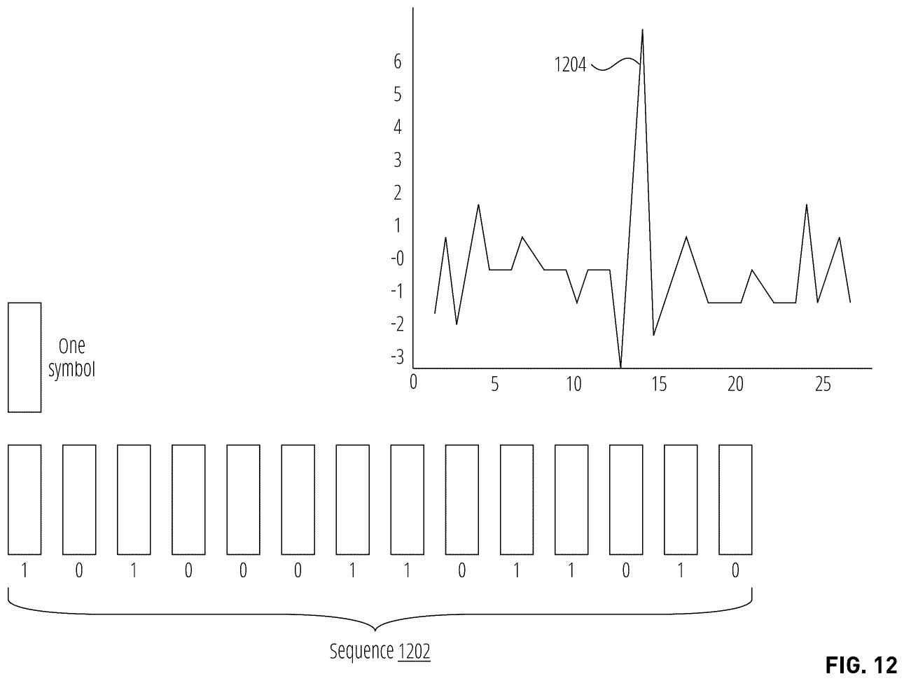

FIG. 12 illustrates an example of a preamble design for a carrier wave transmitted by the carrier wave transmitter in the time domain for DL transmission, according to embodiments herein.

In some embodiments, a preamble sequence design may be introduced in the time domain. For example, to achieve accurate time synchronization, false detection of a preamble should be avoided, and so an auto-correlation peak/second peak of a cross correlation may be maximized. To enable efficient AGC operation, the sequence may avoid long runs of zeros and ones. Further, to enable faster AGC operation, the beginning of the sequence may use repetition/patterning. In some cases, the sequence 1202 has similar number of 0s and 1s.

For example, a sequence 1202 s may include a fourteen 1204 symbols and the sequence 1202 may take the form of 1 0 1 0 0 0 1 1 0 1 1 0 1 0. A local reference is 2s-1 for cross correlation.

In some cases, the length of a sequence may be multiple slots, or multiple slots in combination with a partial slot. For example, two slots may be used totaling 28 symbols. As another example, two slots and a partial slot of four symbols may be used totaling 32 symbols. In such examples, the remaining ten symbols of the third slot may then be a signaling field as discussed herein.

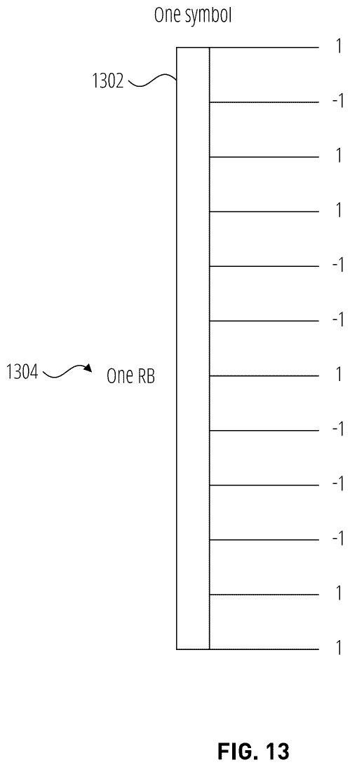

FIG. 13 illustrates an example of a preamble design in the frequency domain for DL transmission, according to embodiments herein.

In some embodiments, a preamble sequence design for the frequency domain may be used. Depending on the ambient IoT system bandwidth, a sequence can be defined in the frequency domain for OFDM symbol generation. For example in one resource block 1304, a symbol 1302 may have a sequence of 1, −1, 1, 1, −1, −1, 1, −1, −1, −1, 1, 1. Further, a high category UE can use the frequency domain sequence detection to improve per symbol detection. A M-sequence or Zadoff-Chu (ZC) sequence can be used as frequency domain sequence.

Embodiments for signaling field design as used in DL transmission are now discussed. The signaling field may be a full slot or part of slot (e.g., a half slot) to indicate, for example, a payload size and/or a modulation scheme (if multiple is supported for different data rate). The signaling field may use basic OOK (e.g., amplitude modulation). Further, both high category IoT tags and low category IoT tags may decode the signaling field.

Embodiments for data payload design as used in the DL transmission are now discussed. The data transmission (e.g., the data payload) follows the signaling field. The data payloads may use the modulation and length field indicated by the signaling field. Further, the transmission may be continuous for multiple slots until all slots are transmitted (e.g., the transmission is finished).

Embodiments herein may contemplate an R2D timing acquisition signal (R-TAS), immediately preceding the transmission of PRDCH. The R-TAS included at least for timing acquisition and indicating the start of R2D transmission in the time domain. An R-TAS structure using a preamble may be studied, in which a start-indicator part provides the start of the R2D transmission, and immediately precedes a clock-acquisition part which is used to determine the OOK chip duration of the subsequent PRDCH transmission. The preamble is not part of PRDCH. The R-TAS start-indicator part is not included in T_{D2R_min}, and an ON/OFF pattern i.e., high/low voltage transmission, is applied. It may be beneficial to further study cases for the start-indicator part. In some cases, an ON-OFF transmission is considered based on energy/edge detection, and multiple alternatives have been studied including a single ON-OFF transmission, i.e. one high-voltage transmission followed by one low-voltage transmission, where ON and OFF may have same or different durations, or a multi-ON-OFF transmission, where different ON and different OFF may have same or different durations and different parts may have same or different duration. In some other cases, an ON-OFF sequence-based design is considered which includes a pre-defined sequence for detection of start-indicator part based on digital correlation. For both cases, it is observed that a fixed duration for the start-indicator part can be considered, regardless of the value of M used for PRDCH transmissions. Further, for both cases, it may be beneficial for the start-indicator part to be distinguishable at least from other parts of the R2D transmissions.

Embodiments herein may contemplate clock-acquisition. For example, the clock-acquisition part is based on OOK without line coding, and includes rising/falling edges, including at least two rising or at least two falling edges for the device to determine the OOK chip duration. Various options for design of the clock-acquisition part may be further studied. In some options, a duration of the clock-acquisition part is variable for different M values, i.e. the duration becomes shorter with increasing value of M. In some other options, a duration of the clock-acquisition part is constant for different M values based on repetition, i.e. repetition factor is increased with increasing value of M to keep the duration constant. Whether/what restriction on M values for the clock-acquisition part may be further discussed.

Embodiments herein may contemplate a PRDCH channel. For example, for R2D, the only physical channel is PRDCH, which carries any higher-layer payload (including system information, if defined), and Layer 1 (L1) R2D control information, if defined. It may be beneficial to study various design cases for PRDCH. In some cases, if there is no L1 R2D control information carried by PRDCH, then PRDCH transmission with only R2D data is considered. Note that in such cases, R2D control information (if any) maybe carried by higher-layer signaling. In some other cases, if any L1 R2D control information is supported & carried by PRDCH, then for the cyclic redundancy check (CRC) attachment (appended if there is non-zero length CRC). In some such cases, a joint CRC is attached to L1 R2D control information and R2D data. In some other such cases, a separate CRC is attached to L1 R2D control information and R2D data, respectively.

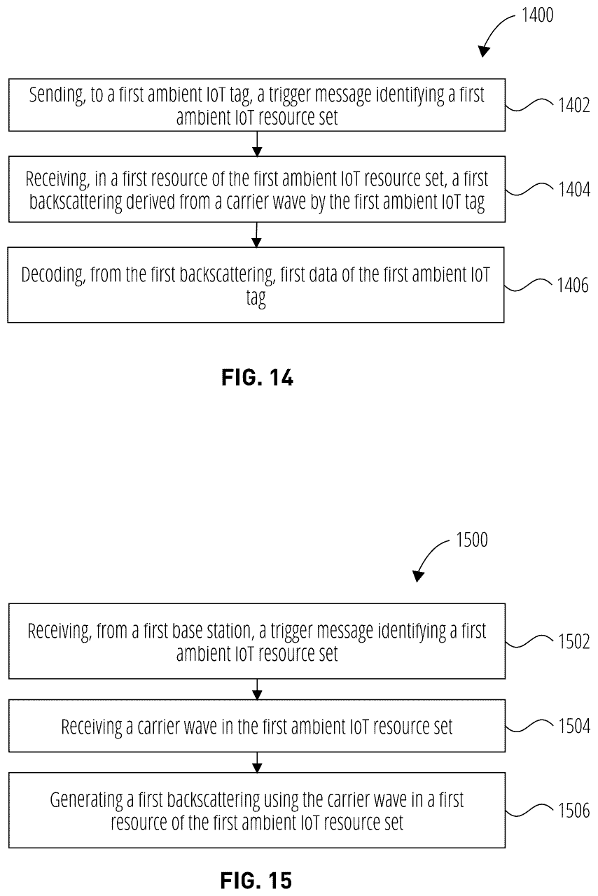

FIG. 14 illustrates a method 1400 of a base station, according to embodiments herein. The illustrated method 1400 includes sending 1402, to a first ambient IoT tag, a trigger message identifying a first ambient IoT resource set. The method 1400 further includes receiving 1404, in a first resource of the first ambient IoT resource set, a first backscattering derived from a carrier wave by the first ambient IoT tag. The method 1400 further includes decoding 1406, from the first backscattering, first data of the first ambient IoT tag.

In some embodiments, the method 1400 further comprises transmitting the carrier wave in the first ambient IoT resource set.

In some embodiments, the method 1400 further comprises sending, to an assisting device, an instruction to transmit the carrier wave in the first ambient IoT resource set.

In some embodiments of the method 1400, the trigger message includes a first indication that the first ambient IoT tag is to generate the first backscattering.

In some embodiments of the method 1400, the trigger message is sent to a second ambient IoT tag, and further comprises receiving, in a second resource of the first ambient IoT resource set, a second backscattering derived from the carrier wave by the second ambient IoT tag, and decoding, from the second backscattering, second data of the second ambient IoT tag. In some such embodiments, the trigger message further includes a second indication that the second ambient IoT tag is to generate the second backscattering.

In some embodiments of the method 1400, the trigger message further identifies a second ambient IoT resource set in which no carrier wave is transmitted; and further comprising receiving, from a second ambient IoT tag, a transmission in a second resource of the second ambient IoT resource set. In some such embodiments, the first ambient IoT resource set and the second ambient IoT resource set are separated in a time domain. In some other such embodiments, the first ambient IoT resource set and the second ambient IoT resource set are overlapping in a time domain and separated in a frequency domain. In certain such embodiments, the first ambient IoT resource set is located on a tone used by the carrier wave. In certain other such embodiments, the first ambient IoT resource set is located on a tone sequence used by the carrier wave.

In some embodiments of the method 1400, the trigger message includes a synchronization preamble for acquiring a frequency and a timing corresponding to the carrier wave.

FIG. 15 illustrates a method 1500 of an ambient IoT tag, according to embodiments herein. The illustrated method 1500 includes receiving 1502, from a first base station, a trigger message identifying a first ambient IoT resource set. The method 1500 further includes receiving 1504 a carrier wave in the first ambient IoT resource set. The method 1500 further includes generating 1506 a first backscattering using the carrier wave in a first resource of the first ambient IoT resource set.

In some embodiments of the method 1500, the carrier wave is received from the base station.

In some embodiments of the method 1500, the carrier wave is received from an assisting device.

In some embodiments of the method 1500, the trigger message includes a first indication that the first ambient IoT tag is to generate the first backscattering.

In some embodiments, the method 1500 further comprises randomly selecting the first resource of the first ambient IoT resource set from one or more resources of the first ambient IoT resource set.

In some embodiments of the method 1500, the trigger message further includes a second indication that a second ambient IoT tag is to generate a second backscattering.

In some embodiments of the method 1500, the trigger message further identifies a second ambient IoT resource set in which no carrier wave is transmitted. In some such embodiments, the first ambient IoT resource set and the second ambient IoT resource set are separated in a time domain. In some other such embodiments, the first ambient IoT resource set and the second ambient IoT resource set are overlapping in a time domain and separated in a frequency domain. In certain such embodiments, the first ambient IoT resource set is located on a tone, and wherein the carrier wave is received on the tone. In certain other such embodiments, the first ambient IoT resource set is located on a tone sequence, and wherein the carrier wave is received on the tone sequence.

In some embodiments of the method 1500, the trigger message includes a synchronization preamble for acquiring a frequency and a timing corresponding to the carrier wave.

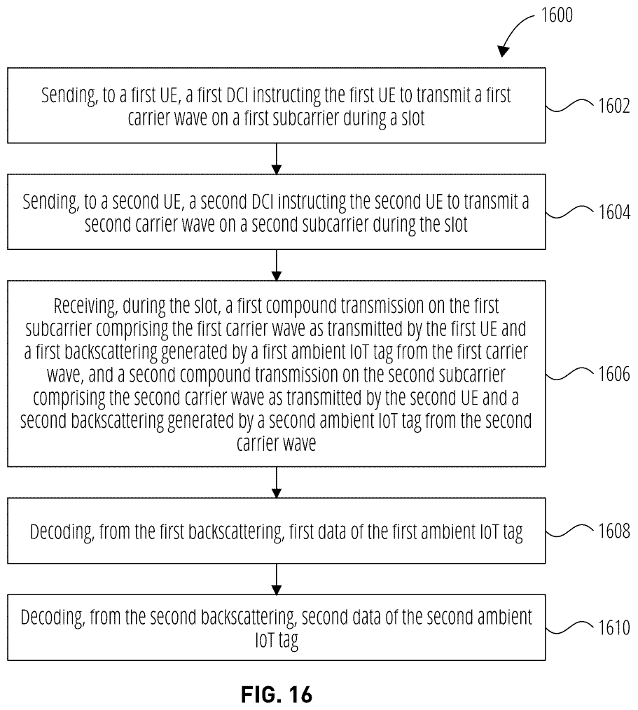

FIG. 16 illustrates a method 1600 of a base station, according to embodiments herein. The illustrated method 1600 includes sending 1602, to a first UE, a first DCI instructing the first UE to transmit a first carrier wave on a first subcarrier during a slot. The method 1600 further includes sending 1604, to a second UE, a second DCI instructing the second UE to transmit a second carrier wave on a second subcarrier during the slot. The method 1600 further includes receiving 1606, during the slot: a first compound transmission on the first subcarrier comprising the first carrier wave as transmitted by the first UE and a first backscattering generated by a first ambient IoT tag from the first carrier wave, and a second compound transmission on the second subcarrier comprising the second carrier wave as transmitted by the second UE and a second backscattering generated by a second ambient IoT tag from the second carrier wave. The method 1600 further includes decoding 1608 from the first backscattering, first data of the first ambient IoT tag. The method 1600 further includes decoding 1610, from the second backscattering, second data of the second ambient IoT tag.

In some embodiments, the method 1600 further comprises isolating the first backscattering from the first compound transmission by estimating a channel between the first UE and the base station, determining, based on the estimation of the channel between the first UE and the base station, a portion of the first compound transmission associated with the first carrier wave as transmitted by the first UE, and subtracting, from the first compound transmission, the portion of the first compound transmission associated with the first carrier wave as transmitted by the first UE. In some such embodiments, the base station estimates the channel between the first UE and the base station by averaging a sum of a number of symbols of the first compound transmission that correspond to a preamble used in the first backscattering.

In some other such embodiments, the number of symbols comprises a first-in-time symbol of the first compound transmission and a second-in-time symbol of the first compound transmission. In certain such embodiments, the number of symbols further comprises a third-in-time symbol of the first compound transmission and a fourth-in-time symbol of the first compound transmission.

In yet some other such embodiments, the base station estimates the channel between the first UE and the base station by taking a measurement of a pre-configured symbol of the first compound transmission as representative of the channel between the first UE and the base station. In certain such embodiments, the pre-configured symbol comprises a second-in-time symbol of the first compound transmission.

In yet some other such embodiments, the base station estimates the channel between the first UE and the base station by taking an average of a plurality of measurements of a plurality of pre-configured symbols of the first compound transmission as representative of the channel between the first UE and the base station. In certain such embodiments, the plurality of pre-configured symbols comprises a third-in-time symbol and a fourth-in-time symbol of the first compound transmission.

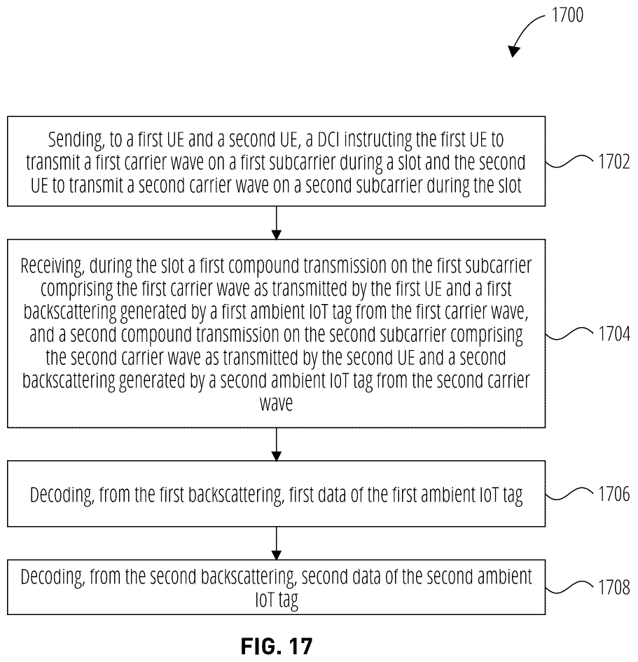

FIG. 17 illustrates a method 1700 of a base station, according to embodiments herein. The illustrated method 1700 includes sending 1702, to a first UE and a second UE, a DCI instructing the first UE to transmit a first carrier wave on a first subcarrier during a slot and the second UE to transmit a second carrier wave on a second subcarrier during the slot. The method 1700 further includes receiving 1704, during the slot: a first compound transmission on the first subcarrier comprising the first carrier wave as transmitted by the first UE and a first backscattering generated by a first ambient IoT tag from the first carrier wave, and a second compound transmission on the second subcarrier comprising the second carrier wave as transmitted by the second UE and a second backscattering generated by a second ambient IoT tag from the second carrier wave. The method 1700 further includes decoding 1706 from the first backscattering, first data of the first ambient IoT tag. The method 1700 further includes decoding 1708, from the second backscattering, second data of the second ambient IoT tag.

In some embodiments, the method 1700 further comprises isolating the first backscattering from the first compound transmission by estimating a channel between the first UE and the base station, determining, based on the estimation of the channel between the first UE and the base station, a portion of the first compound transmission associated with the first carrier wave as transmitted by the first UE, and subtracting, from the first compound transmission, the portion of the first compound transmission associated with the first carrier wave as transmitted by the first UE. In some such embodiments, the base station estimates the channel between the first UE and the base station by averaging a sum of a number of symbols of the first compound transmission that correspond to a preamble used in the first backscattering. In certain such embodiments, the number of symbols comprises a first-in-time symbol of the first compound transmission and a second-in-time symbol of the first compound transmission. In certain such embodiments, the number of symbols further comprises a third-in-time symbol of the first compound transmission and a fourth-in-time symbol of the first compound transmission.

In some other such embodiments, the base station estimates the channel between the first UE and the base station by taking a measurement of a pre-configured symbol of the first compound transmission as representative of the channel between the first UE and the base station. In certain such embodiments, the pre-configured symbol comprises a second-in-time symbol of the first compound transmission.

In yet some other such embodiments, the base station estimates the channel between the first UE and the base station by taking an average of a plurality of measurements of a plurality of pre-configured symbols of the first compound transmission as representative of the channel between the first UE and the base station. In certain such embodiments, the plurality of pre-configured symbols comprises a third-in-time symbol and a fourth-in-time symbol of the first compound transmission.

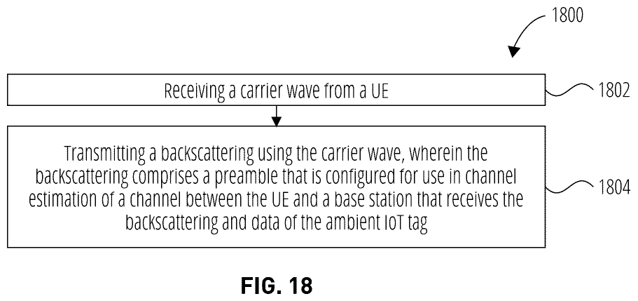

FIG. 18 illustrates a method 1800 of an ambient IoT tag, according to embodiments herein. The illustrated method 1800 includes receiving 1802 a carrier wave from a UE. The method 1800 further includes transmitting 1804 a backscattering using the carrier wave, wherein the backscattering comprises a preamble that is configured for use in channel estimation of a channel between the UE and a base station that receives the backscattering and data of the ambient IoT tag.

In some embodiments of the method 1800, a first portion of the preamble is orthogonal to a second portion of the preamble. In some such embodiments, the first portion of the preamble comprises a first-in-time symbol of the backscattering and the second portion of the preamble comprises a second-in-time symbol of the backscattering. In some other such embodiments, the first portion of the preamble comprises a first-in-time symbol of the backscattering and a second-in-time symbol of the backscattering and the second portion of the preamble comprises a third in-time symbol of the backscattering and a fourth-in-time symbol of the backscattering.

In some embodiments of the method 1800, the preamble is configured to cause the backscattering to include an unmodulated portion of the carrier wave. In some such embodiments, the unmodulated portion comprises a second-in-time symbol of the backscattering. In some other such embodiments, the unmodulated portion comprises a third-in-time symbol of the backscattering and a fourth-in-time symbol of the backscattering.

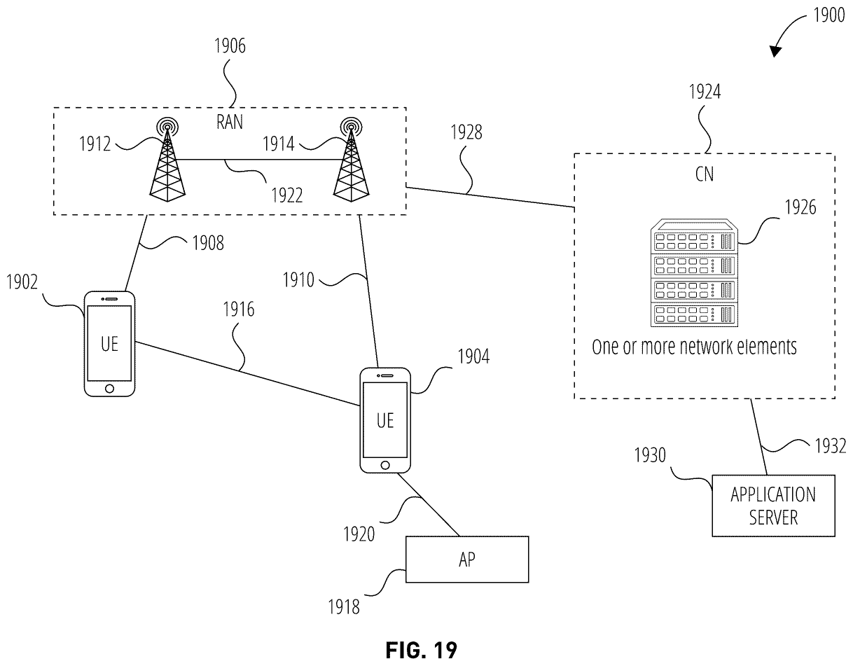

FIG. 19 illustrates an example architecture of a wireless communication system 1900, according to embodiments disclosed herein. The following description is provided for an example wireless communication system 1900 that operates in conjunction with the LTE system standards and/or 5G or NR system standards as provided by 3GPP technical specifications.

As shown by FIG. 19, the wireless communication system 1900 includes UE 1902 and UE 1904 (although any number of UEs may be used). In this example, the UE 1902 and the UE 1904 are illustrated as smartphones (e.g., handheld touchscreen mobile computing devices connectable to one or more cellular networks), but may also comprise any mobile or non-mobile computing device configured for wireless communication.

The UE 1902 and UE 1904 may be configured to communicatively couple with a RAN 1906. In embodiments, the RAN 1906 may be NG-RAN, E-UTRAN, etc. The UE 1902 and UE 1904 utilize connections (or channels) (shown as connection 1908 and connection 1910, respectively) with the RAN 1906, each of which comprises a physical communications interface. The RAN 1906 can include one or more base stations (such as base station 1912 and base station 1914) that enable the connection 1908 and connection 1910.

In this example, the connection 1908 and connection 1910 are air interfaces to enable such communicative coupling, and may be consistent with RAT(s) used by the RAN 1906, such as, for example, an LTE and/or NR.

In some embodiments, the UE 1902 and UE 1904 may also directly exchange communication data via a sidelink interface 1916. The UE 1904 is shown to be configured to access an access point (shown as AP 1918) via connection 1920. By way of example, the connection 1920 can comprise a local wireless connection, such as a connection consistent with any IEEE 802.11 protocol, wherein the AP 1918 may comprise a Wi-Fi® router. In this example, the AP 1918 may be connected to another network (for example, the Internet) without going through a CN 1924.

In embodiments, the UE 1902 and UE 1904 can be configured to communicate using orthogonal frequency division multiplexing (OFDM) communication signals with each other or with the base station 1912 and/or the base station 1914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1912 or base station 1914 may be implemented as one or more software entities running on server computers as part of a virtual network. In addition, or in other embodiments, the base station 1912 or base station 1914 may be configured to communicate with one another via interface 1922. In embodiments where the wireless communication system 1900 is an LTE system (e.g., when the CN 1924 is an EPC), the interface 1922 may be an X2 interface. The X2 interface may be defined between two or more base stations (e.g., two or more eNBs and the like) that connect to an EPC, and/or between two eNBs connecting to the EPC. In embodiments where the wireless communication system 1900 is an NR system (e.g., when CN 1924 is a 5GC), the interface 1922 may be an Xn interface. The Xn interface is defined between two or more base stations (e.g., two or more gNBs and the like) that connect to 5GC, between a base station 1912 (e.g., a gNB) connecting to 5GC and an CNB, and/or between two eNBs connecting to 5GC (e.g., CN 1924).

The RAN 1906 is shown to be communicatively coupled to the CN 1924. The CN 1924 may comprise one or more network elements 1926, which are configured to offer various data and telecommunications services to customers/subscribers (e.g., users of UE 1902 and UE 1904) who are connected to the CN 1924 via the RAN 1906. The components of the CN 1924 may be implemented in one physical device or separate physical devices including components to read and execute instructions from a machine-readable or computer-readable medium (e.g., a non-transitory machine-readable storage medium).

In embodiments, the CN 1924 may be an EPC, and the RAN 1906 may be connected with the CN 1924 via an S1 interface 1928. In embodiments, the S1 interface 1928 may be split into two parts, an S1 user plane (S1-U) interface, which carries traffic data between the base station 1912 or base station 1914 and a serving gateway (S-GW), and the S1-MME interface, which is a signaling interface between the base station 1912 or base station 1914 and mobility management entities (MMEs).

In embodiments, the CN 1924 may be a 5GC, and the RAN 1906 may be connected with the CN 1924 via an NG interface 1928. In embodiments, the NG interface 1928 may be split into two parts, an NG user plane (NG-U) interface, which carries traffic data between the base station 1912 or base station 1914 and a user plane function (UPF), and the S1 control plane (NG-C) interface, which is a signaling interface between the base station 1912 or base station 1914 and access and mobility management functions (AMFs).

Generally, an application server 1930 may be an element offering applications that use internet protocol (IP) bearer resources with the CN 1924 (e.g., packet switched data services). The application server 1930 can also be configured to support one or more communication services (e.g., VoIP sessions, group communication sessions, etc.) for the UE 1902 and UE 1904 via the CN 1924. The application server 1930 may communicate with the CN 1924 through an IP communications interface 1932.

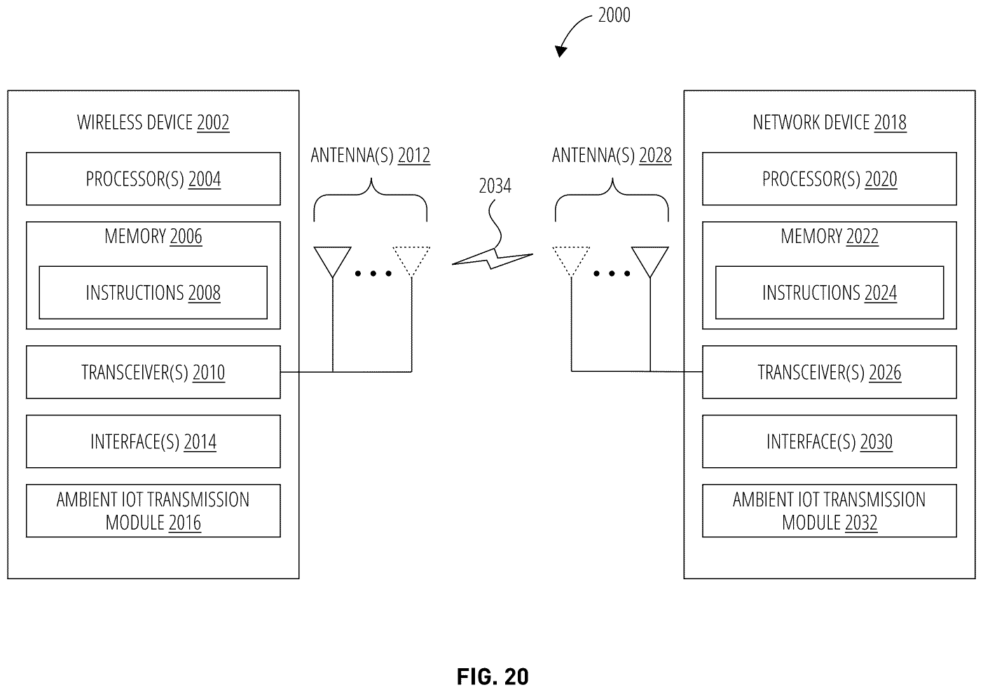

FIG. 20 illustrates a system 2000 for performing signaling 2034 between a wireless device 2002 and a network device 2018, according to embodiments disclosed herein. The system 2000 may be a portion of a wireless communications system as herein described. The wireless device 2002 may be, for example, a UE of a wireless communication system. The network device 2018 may be, for example, a base station (e.g., an eNB or a gNB) of a wireless communication system.

The wireless device 2002 may include one or more processor(s) 2004. The processor(s) 2004 may execute instructions such that various operations of the wireless device 2002 are performed, as described herein. The processor(s) 2004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2002 may include a memory 2006. The memory 2006 may be a non-transitory computer-readable storage medium that stores instructions 2008 (which may include, for example, the instructions being executed by the processor(s) 2004). The instructions 2008 may also be referred to as program code or a computer program. The memory 2006 may also store data used by, and results computed by, the processor(s) 2004.

The wireless device 2002 may include one or more transceiver(s) 2010 that may include radio frequency (RF) transmitter circuitry and/or receiver circuitry that use the antenna(s) 2012 of the wireless device 2002 to facilitate signaling (e.g., the signaling 2034) to and/or from the wireless device 2002 with other devices (e.g., the network device 2018) according to corresponding RATs.

The wireless device 2002 may include one or more antenna(s) 2012 (e.g., one, two, four, or more). For embodiments with multiple antenna(s) 2012, the wireless device 2002 may leverage the spatial diversity of such multiple antenna(s) 2012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 2002 may be accomplished according to precoding (or digital beamforming) that is applied at the wireless device 2002 that multiplexes the data streams across the antenna(s) 2012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2002 may implement analog beamforming techniques, whereby phases of the signals sent by the antenna(s) 2012 are relatively adjusted such that the (joint) transmission of the antenna(s) 2012 can be directed (this is sometimes referred to as beam steering).

The wireless device 2002 may include one or more interface(s) 2014. The interface(s) 2014 may be used to provide input to or output from the wireless device 2002. For example, a wireless device 2002 that is a UE may include interface(s) 2014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 2010/antenna(s) 2012 already described) that allow for communication between the UE and other devices and may operate according to known protocols (e.g., Wi-Fi®, Bluetooth®, and the like).

The wireless device 2002 may include an ambient IoT transmission module 2016. The ambient IoT transmission module 2016 may be implemented via hardware, software, or combinations thereof. For example, the ambient IoT transmission module 2016 may be implemented as a processor, circuit, and/or instructions 2008 stored in the memory 2006 and executed by the processor(s) 2004. In some examples, the ambient IoT transmission module 2016 may be integrated within the processor(s) 2004 and/or the transceiver(s) 2010. For example, the ambient IoT transmission module 2016 may be implemented by a combination of software components (e.g., executed by a DSP or a general processor) and hardware components (e.g., logic gates and circuitry) within the processor(s) 2004 or the transceiver(s) 2010.

The ambient IoT transmission module 2016 may be used for various aspects of the present disclosure, for example, aspects of FIG. 1 through FIG. 18. In some cases, the ambient IoT transmission module 2016 may be configured to cause a wireless device 2002 to receive, from a first network device 2018, a trigger message identifying a first ambient IoT resource set. The ambient IoT transmission module 2016 may be further configured to cause a wireless device 2002 to receive a carrier wave in the first ambient IoT resource set. The ambient IoT transmission module 2016 may be further configured to cause a wireless device 2002 to generate a first backscattering using the carrier wave in a first resource of the first ambient IoT resource set.

In other some cases, the ambient IoT transmission module 2016 may be configured to cause a wireless device 2002 to receive a carrier wave from a wireless device 2002 and transmit a backscattering using the carrier wave, wherein the backscattering comprises a preamble that is configured for use in channel estimation of a channel between the wireless device 2002 and a network device 2018 that receives the backscattering and data of the ambient IoT tag.

The network device 2018 may include one or more processor(s) 2020. The processor(s) 2020 may execute instructions such that various operations of the network device 2018 are performed, as described herein. The processor(s) 2020 may include one or more baseband processors implemented using, for example, a CPU, a DSP, an ASIC, a controller, an FPGA device, another hardware device, a firmware device, or any combination thereof configured to perform the operations described herein.

The network device 2018 may include a memory 2022. The memory 2022 may be a non-transitory computer-readable storage medium that stores instructions 2024 (which may include, for example, the instructions being executed by the processor(s) 2020). The instructions 2024 may also be referred to as program code or a computer program. The memory 2022 may also store data used by, and results computed by, the processor(s) 2020.

The network device 2018 may include one or more transceiver(s) 2026 that may include RF transmitter circuitry and/or receiver circuitry that use the antenna(s) 2028 of the network device 2018 to facilitate signaling (e.g., the signaling 2034) to and/or from the network device 2018 with other devices (e.g., the wireless device 2002) according to corresponding RATs.

The network device 2018 may include one or more antenna(s) 2028 (e.g., one, two, four, or more). In embodiments having multiple antenna(s) 2028, the network device 2018 may perform MIMO, digital beamforming, analog beamforming, beam steering, etc., as has been described.

The network device 2018 may include one or more interface(s) 2030. The interface(s) 2030 may be used to provide input to or output from the network device 2018. For example, a network device 2018 that is a base station may include interface(s) 2030 made up of transmitters, receivers, and other circuitry (e.g., other than the transceiver(s) 2026/antenna(s) 2028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 2018 may include an ambient IoT transmission module 2032. The ambient IoT transmission module 2032 may be implemented via hardware, software, or combinations thereof. For example, the ambient IoT transmission module 2032 may be implemented as a processor, circuit, and/or instructions 2024 stored in the memory 2022 and executed by the processor(s) 2020. In some examples, the ambient IoT transmission module 2032 may be integrated within the processor(s) 2020 and/or the transceiver(s) 2026. For example, the ambient IoT transmission module 2032 may be implemented by a combination of software components (e.g., executed by a DSP or a general processor) and hardware components (e.g., logic gates and circuitry) within the processor(s) 2020 or the transceiver(s) 2026.

The ambient IoT transmission module 2032 may be used for various aspects of the present disclosure, for example, aspects of FIG. 1 through FIG. 18. In some cases, the ambient IoT transmission module 2032 is configured to cause the network device 2018 to send, to a first wireless device 2002, a trigger message identifying a first ambient IoT resource set. The ambient IoT transmission module 2032 may be further configured to cause the network device 2018 to receive, in a first resource of the first ambient IoT resource set, a first backscattering derived from a carrier wave by the first ambient IoT tag. The ambient IoT transmission module 2032 may be further configured to cause the network device 2018 to decode, from the first backscattering, first data of the first ambient IoT tag.

In some other cases, the ambient IoT transmission module 2032 may be configured to cause the network device 2018 to send, to a first wireless device 2002, a first DCI instructing the first UE to transmit a first carrier wave of a first tone during a slot. The ambient IoT transmission module 2032 may be further configured to cause the network device 2018 to send, to a second wireless device 2002, a second DCI instructing the second UE to transmit a second carrier wave of a second tone during the slot and receive, during the slot: a first compound transmission on the first tone comprising the first carrier wave as transmitted by the first UE and a first backscattering generated by a first ambient IoT tag from the first carrier wave, and a second compound transmission on the second tone comprising the second carrier wave as transmitted by the second UE and a second backscattering generated by a second ambient IoT tag from the second carrier wave. The ambient IoT transmission module 2032 may be further configured to cause the network device 2018 to decode, from the first backscattering, first data of the first ambient IoT tag and decode, from the second backscattering, second data of the second ambient IoT tag.

In yet some other cases, the ambient IoT transmission module 2032 may be configured to cause the network device 2018 to send, to a first wireless device 2002 and a second wireless device 2002, a DCI instructing the first UE to transmit a first carrier wave of a first tone during a slot and the second UE to transmit a second carrier wave of a second tone during the slot and receive, during the slot: a first compound transmission on the first tone comprising the first carrier wave as transmitted by the first UE and a first backscattering generated by a first ambient IoT tag from the first carrier wave, and a second compound transmission on the second tone comprising the second carrier wave as transmitted by the second UE and a second backscattering generated by a second ambient IoT tag from the second carrier wave. The ambient IoT transmission module 2032 may be further configured to cause the network device 2018 to decode, from the first backscattering, first data of the first ambient IoT tag and decode, from the second backscattering, second data of the second ambient IoT tag.

Embodiments contemplated herein include an apparatus comprising means to perform one or more elements of the method 1500 and the method 1800. This apparatus may be, for example, an apparatus of a UE (such as a wireless device 2002 that is a UE, as described herein).

Embodiments contemplated herein include one or more non-transitory computer-readable media comprising instructions to cause an electronic device, upon execution of the instructions by one or more processors of the electronic device, to perform one or more elements of the method 1500 and the method 1800. This non-transitory computer-readable media may be, for example, a memory of a UE (such as a memory 2006 of a wireless device 2002 that is a UE, as described herein).

Embodiments contemplated herein include an apparatus comprising logic, modules, or circuitry to perform one or more elements of the method 1500 and the method 1800. This apparatus may be, for example, an apparatus of a UE (such as a wireless device 2002 that is a UE, as described herein).

Embodiments contemplated herein include an apparatus comprising: one or more processors and one or more computer-readable media comprising instructions that, when executed by the one or more processors, cause the one or more processors to perform one or more elements of the method 1500 and the method 1800. This apparatus may be, for example, an apparatus of a UE (such as a wireless device 2002 that is a UE, as described herein).

Embodiments contemplated herein include a signal as described in or related to one or more elements of the method 1500 and the method 1800.

Embodiments contemplated herein include a computer program or computer program product comprising instructions, wherein execution of the program by a processor is to cause the processor to carry out one or more elements of the method 1500 and the method 1800. The processor may be a processor of a UE (such as a processor(s) 2004 of a wireless device 2002 that is a UE, as described herein). These instructions may be, for example, located in the processor and/or on a memory of the UE (such as a memory 2006 of a wireless device 2002 that is a UE, as described herein).

Embodiments contemplated herein include an apparatus comprising means to perform one or more elements of the method 1400, the method 1600 and the method 1700. This apparatus may be, for example, an apparatus of a base station (such as a network device 2018 that is a base station, as described herein).

Embodiments contemplated herein include one or more non-transitory computer-readable media comprising instructions to cause an electronic device, upon execution of the instructions by one or more processors of the electronic device, to perform one or more elements of the method 1400, the method 1600 and the method 1700. This non-transitory computer-readable media may be, for example, a memory of a base station (such as a memory 2022 of a network device 2018 that is a base station, as described herein).

Embodiments contemplated herein include an apparatus comprising logic, modules, or circuitry to perform one or more elements of the method 1400, the method 1600 and the method 1700. This apparatus may be, for example, an apparatus of a base station (such as a network device 2018 that is a base station, as described herein).

Embodiments contemplated herein include an apparatus comprising: one or more processors and one or more computer-readable media comprising instructions that, when executed by the one or more processors, cause the one or more processors to perform one or more elements of the method 1400, the method 1600 and the method 1700. This apparatus may be, for example, an apparatus of a base station (such as a network device 2018 that is a base station, as described herein).

Embodiments contemplated herein include a signal as described in or related to one or more elements of the method 1400, the method 1600 and the method 1700.

Embodiments contemplated herein include a computer program or computer program product comprising instructions, wherein execution of the program by a processing element is to cause the processing element to carry out one or more elements of the method 1400, the method 1600 and the method 1700. The processor may be a processor of a base station (such as a processor(s) 2020 of a network device 2018 that is a base station, as described herein). These instructions may be, for example, located in the processor and/or on a memory of the base station (such as a memory 2022 of a network device 2018 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a base station, comprising:
sending, to a first user equipment (UE), a first downlink control information (DCI) instructing the first UE to transmit a first carrier wave on a first subcarrier during a slot;
sending, to a second UE, a second DCI instructing the second UE to transmit a second carrier wave on a second subcarrier during the slot;
receiving, during the slot:
a first compound transmission on the first subcarrier comprising the first carrier wave as transmitted by the first UE and a first backscattering generated by a first ambient internet of things(IoT) tag from the first carrier wave; and
a second compound transmission on the second subcarrier comprising the second carrier wave as transmitted by the second UE and a second backscattering generated by a second ambient IoT tag from the second carrier wave;
decoding, from the first backscattering, first data of the first ambient IoT tag; and
decoding, from the second backscattering, second data of the second ambient IoT tag.

2. The method of claim 1, further comprising isolating the first backscattering from the first compound transmission by:
estimating a channel between the first UE and the base station;
determining, based on the estimation of the channel between the first UE and the base station, a portion of the first compound transmission associated with the first carrier wave as transmitted by the first UE; and
subtracting, from the first compound transmission, the portion of the first compound transmission associated with the first carrier wave as transmitted by the first UE.

3. The method of claim 2, wherein the base station estimates the channel between the first UE and the base station by averaging a sum of a number of symbols of the first compound transmission that correspond to a preamble used in the first backscattering.

4. The method of claim 3, wherein the number of symbols comprises a first-in-time symbol of the first compound transmission and a second-in-time symbol of the first compound transmission.

5. The method of claim 4, wherein the number of symbols further comprises a third-in-time symbol of the first compound transmission and a fourth-in-time symbol of the first compound transmission.

6. The method of claim 2, wherein the base station estimates the channel between the first UE and the base station by taking a measurement of a pre-configured symbol of the first compound transmission as representative of the channel between the first UE and the base station.

7. The method of claim 2, wherein the base station estimates the channel between the first UE and the base station by taking an average of a plurality of measurements of a plurality of pre-configured symbols of the first compound transmission as representative of the channel between the first UE and the base station.

8. The method of claim 7, wherein the plurality of pre-configured symbols comprises a third-in-time symbol and a fourth-in-time symbol of the first compound transmission.

9. A method of a base station, comprising:
sending, to a first user equipment (UE) and a second UE, a downlink control information (DCI) instructing the first UE to transmit a first carrier wave on a first subcarrier during a slot and the second UE to transmit a second carrier wave on a second subcarrier during the slot;
receiving, during the slot:
a first compound transmission on the first subcarrier comprising the first carrier wave as transmitted by the first UE and a first backscattering generated by a first ambient internet of things(IoT) tag from the first carrier wave; and
a second compound transmission on the second subcarrier comprising the second carrier wave as transmitted by the second UE and a second backscattering generated by a second ambient IoT tag from the second carrier wave;
decoding, from the first backscattering, first data of the first ambient IoT tag; and
decoding, from the second backscattering, second data of the second ambient IoT tag.

10. The method of claim 9, further comprising isolating the first backscattering from the first compound transmission by:
estimating a channel between the first UE and the base station;
determining, based on the estimation of the channel between the first UE and the base station, a portion of the first compound transmission associated with the first carrier wave as transmitted by the first UE; and
subtracting, from the first compound transmission, the portion of the first compound transmission associated with the first carrier wave as transmitted by the first UE.

11. The method of claim 10, wherein the base station estimates the channel between the first UE and the base station by averaging a sum of a number of symbols of the first compound transmission that correspond to a preamble used in the first backscattering.

12. The method of claim 10, wherein the base station estimates the channel between the first UE and the base station by taking a measurement of a pre-configured symbol of the first compound transmission as representative of the channel between the first UE and the base station.

13. The method of claim 12, wherein the pre-configured symbol comprises a second-in-time symbol of the first compound transmission.

14. The method of claim 10, wherein the base station estimates the channel between the first UE and the base station by taking an average of a plurality of measurements of a plurality of pre-configured symbols of the first compound transmission as representative of the channel between the first UE and the base station.

15. The method of claim 14, wherein the plurality of pre-configured symbols comprises a third-in-time symbol and a fourth-in-time symbol of the first compound transmission.

16. A method of an ambient internet of things(IoT) tag, comprising:
receiving a carrier wave from a user equipment (UE); and
transmitting a backscattering using the carrier wave, wherein the backscattering comprises a preamble that is configured for use in channel estimation of a channel between the UE and a base station that receives the backscattering and data of the ambient IoT tag.

17. The method of claim 16, wherein a first portion of the preamble is orthogonal to a second portion of the preamble.

18. The method of claim 17, wherein the first portion of the preamble comprises a first-in-time symbol of the backscattering and the second portion of the preamble comprises a second-in-time symbol of the backscattering.

19. The method of claim 17, wherein the first portion of the preamble comprises a first-in-time symbol of the backscattering and a second-in-time symbol of the backscattering and the second portion of the preamble comprises a third in-time symbol of the backscattering and a fourth-in-time symbol of the backscattering.

20. The method of claim 16, wherein the preamble is configured to cause the backscattering to include an unmodulated portion of the carrier wave.
